(19) United States
(12) Patent Application Publication
(10) Pub. No.: US 2025/0269434 A1
(43) Pub. Date: Aug. 28, 2025

(54) FABRICATION OF 3D MULTI-MATERIAL PARTS WITH SPATIALLY TUNABLE MULTI-SCALE POROSITY AND BIOCOMPATIBLE CERAMIC COATING

(71) Applicant: UNIVERSITY OF FLORIDA RESEARCH FOUNDATION, INCORPORATED, Gainesville, FL (US)

(72) Inventors: Yong Huang, Gainesville, FL (US); Bing Ren, Gainesville, FL (US); Marc Sole Gras, Gainesville, FL (US)

(21) Appl. No.: 18/871,329

(22) PCT Filed: Jun. 2, 2023
(86) PCT No.: PCT/US2023/067838

§ 371 Date: Dec. 3, 2024

Related U.S. Application Data
(60) Provisional application No. 63/349,800, filed on Jun. 7, 2022.

(51) Int. Cl. B22F 12/55; B22F 10/14; B22F 10/64; B28B 1/00; B33Y 10/00; B33Y 30/00; B33Y 40/20

(52) U.S. Cl. CPC B22F 12/55; B22F 10/14; B22F 10/64; B28B 1/001; B33Y 10/00; B33Y 30/00; B33Y 40/20

(57) ABSTRACT

Described are systems. apparatuses. and methods for three-dimensional (3D) printing engineered parts having spatially tunable porosity. Printing ink can include metal/ceramic powders, binder(s), sinterable additive(s), polymer(s), porogen(s), and/or solvent(s). Vapor-based phase separation of the printing material causes at least partial solidification of ink to form a green part. A coagulation bath can be used to complete solidification of the green part and remove porogen material(s). Debinding the green part removes polymer(s) and/or porogen material(s) to form a porous, sinterable part. Sintering densifies the debinded part, controls grain growth/size, and improves mechanical properties of the part. Tuning concentration and particle size of porogen in the ink and/or the inter-filament spacing during printing achieves desired porosity and pore size in the finished part. Biocompatible ceramic coating(s) disposed on the part through microbially-induced biomineralization may increase osseointegration performance for bone tissue engineering applications.

### CROSS-REFERENCE TO RELATED APPLICATIONS

This application claims the benefit of priority to U.S. Provisional Application Ser. No. 63/349,800, filed June 7, 2022 and entitled “Fabrication of 3D Multi-Material Parts with Spatially Tunable Multi-Scale Porosity and Biocompatible Ceramic Coating,” the entire disclosure of which is hereby incorporated herein by reference in its entirety for all purposes.

### FIELD

This application relates generally to three-dimensional (3D) printing, and more particularly to 3D printing of multi-material parts with tunable porosity that are biocompatible.

### BACKGROUND

Additive manufacturing, also commonly known as three-dimensional (3D) printing, encompasses a range of technologies used to fabricate parts by adding material to build up the part rather than by subtracting unwanted material away from a bulk starting workpiece. For freeform 3D printing of functional structures, extrusion, sometimes known as direct ink writing, can be used due to its ease of implementation, high efficiency, and wide range of printable materials. However, conventional direct ink writing methods and relevant compositions are typically not appropriate for printing metallic parts, such as, multi-material, porous metallic parts.

Bone tissue is a rigid material that comprises cortex, trabeculae, marrow, osteoblast cells, osteocyte cells, and osteoclast cells. Bone often has a honeycomb matrix structure internally, making it light, rigid, and strong. Bone tissue engineering uses biocompatible materials, or biomaterials, for generating scaffold materials that are useful for bone regrowth, bone grafting, and/or the like. Functional materials, such as stem cells, signaling molecules, and additives for improved mechanical strength and durability, can be added to scaffold materials.

Autologous bone grafting is often considered a current best practice in bone tissue engineering for new bone growth; however, it often fails to harvest enough autologous bone segments and is therefore ineffective for large bone growth for clinical needs, among other applications.

Metals and metal alloys are often used as a scaffold for bone tissue engineering applications, but current additive manufacturing and 3D printing approaches are insufficient for forming complex scaffold structures from metals and/or metal alloys. Through applied effort, ingenuity, and innovation, solutions to improve such apparatuses, systems, and methods have been realized and are described in connection with embodiments of the present invention.

### SUMMARY

Described generally herein, according to at least some embodiments, are apparatuses, systems, and methods for three-dimensional (3D) printing of engineered parts with spatially tunable porosity. A printing material can include engineering powder(s) (e.g., metals or ceramics), binder(s), sinterable additive(s), polymer(s), porogen(s), and/or solvent(s). During 3D printing, vapor-based phase inversion of the printing material causes at least partial solidification to form a green part. The part can be immersed in a coagulation bath for complete solidification if needed. Debinding of the part can remove some or all of the polymer(s). The printed parts present different porous features that are defined by the inter-filament spacing and intra-filament pores, being such features defined by the printing path and the incorporation of porogen material(s), respectively. The porogen material(s) can be removed to form a porous, sinterable part. The part is then sintered to densify the metallic and/or ceramic phase and improve mechanical properties of the part. A biocompatible ceramic coating can be applied to the part to increase biocompatibility. The ratio of porogen to other components of the printing material can be adjusted (i.e., tuned) to achieve a desired porosity and pore size in the finished part.

According to one embodiment, a method can be carried out that comprises: preparing a printing material comprising one or more engineering powders, one or more porogen materials, and one or more binder materials; printing the printing material into a printing space; and at least partially solidifying the printing material during the printing to form a green part. In some embodiments, the method can further comprise: partially solidifying the printing material during the printing to form the green part by delivering a non-solvent vapor to the printing material during printing to cause a vapor-induced phase separation (also known as phase inversion) of the one or more binder materials. In some embodiments, the method can further comprise: removing the one or more porogen materials. In some embodiments, the method can further comprise: sintering the green part to form a sintered part, by increasing a temperature of the green part from the temperature of the green part once formed to a temperature lower or greater than the melting point of one of the included components. In some embodiments, the method can further comprise: adjusting the printing path to obtain as-designed inter-filament spacing in order to spatially tune the part's porosity at a macro-scale level. In some embodiments, the method can further comprise: adjusting a ratio of the one or more porogen materials to the one or more engineering powders and the one or more binder materials prior to printing the printing material into the printing space to spatially tune the porosity and/or pore size of the sintered part at the intra-filament, micro-scale level. In some embodiments, the method can further comprise: at least partially coating the sintered part with a ceramic coating to form a finished part.

In some embodiments, the one or more engineering powders can comprise one or more of: a ceramic, carbon, silica, clay, sand, silt, mud, loam, a metal, kaolinite, montmorillonite, hydrous aluminum phyllosilicates, illite, vermiculite, magnesium silicates, aluminum silicate hydroxide, porcelain, lime, iron oxide, magnesia, alumina, nitrides, carbides, beryllias, cerias, zirconias, borides, silicides, or combinations thereof.

In some embodiments, the one or more engineering powders can comprise a metal selected from among: stainless steel, carbon, iron, cobalt, chromium, titanium, gold, calcium, phosphorous, gallium, lithium, magnesium, manganese, silver, strontium, vanadium, aluminum, tantalum, nickel, nitrogen, copper, zinc, zirconium, hafnium, niobium, yttrium, thoria, molybdenum, oxides thereof, alloys thereof, or any combination thereof.

In some embodiments, the one or more porogen materials can comprise one or more of: a salt, a sugar, a wax, a gel, a protein, a peptide, a biomaterial, a sol-gel, a rubber, alginate, a polymer, high intemal phase emulsions, polycaprolactone, calcium phosphate, thermoplastic polymers, crystals thereof, beads thereof, or combinations thereof.

In some embodiments, the one or more binder materials can comprise a polymer.

In some embodiments, the printing of the printing material into the printing space can comprise printing by layer-by-laver stacking, powder bed fusion, direction deposition technology, extrusion, injection molding, or a combination thereof.

In some embodiments, the sintering of the green part can comprise one or more of: selective layer sintering, selective laser melting, electron beam melting, direct metal laser sintering, capacitor discharge sintering, continuous mesh belt furnace sintering, electro sinter forging, pressure-less sintering, microwave sintering, spark plasma sintering, electric current assisted sintering, transient liquid phase sintering, permanent liquid phase sintering, liquid phase sintering metallic powder sintering, hot isostatic pressing, direct current in vacuum sintering, sinter hardening, tempering, or fritting.

According to another embodiment, an apparatus can be provided that comprises: a processor; a memory storing computer program code, wherein the memory and the computer program code are configured, with the processor, to cause the apparatus to carry out at least the following: preparing a printing material comprising one or more engineering powders, one or more porogen materials, and one or more binder materials; printing the printing material into a printing space; and at least partially solidifying the printing material during the printing to form a green part.

In some embodiments, the memory and the computer program code are further configured, with the processor, to cause the apparatus to carry out at least the following: partially solidifying the printing material during the printing to form the green part by delivering a non-solvent vapor to the printing material during printing to cause a vapor-induced phase separation of the one or more binder materials.

In some embodiments, the memory and the computer program code are further configured, with the processor, to cause the apparatus to carry out at least the following: removing the one or more porogen materials.

In some embodiments, the memory and the computer program code are further configured, with the processor, to cause the apparatus to carry out at least the following: sintering the green part to form a sintered part, by increasing a temperature of the green part from the temperature of the green part once formed to a temperature lower or greater than the melting point of one of the included components.

In some embodiments, the memory and the computer program code are further configured, with the processor, to cause the apparatus to carry out at least the following: adjusting a ratio of the one or more porogen materials to the one or more engineering powders and the one or more binder materials prior to printing the printing material into the printing space to spatially tune the porosity and/or pore size of the sintered part.

In some embodiments, the memory and the computer program code are further configured, with the processor, to cause the apparatus to carry out at least the following: at least partially coating the sintered part with a ceramic coating to form a finished part.

In some embodiments, the one or more engineering powders can comprise one or more of: a ceramic, carbon, silica, clay, sand, silt, mud, loam, a metal, kaolinite, montmorillonite, hydrous aluminum phyllosilicates, illite, vermiculite, magnesium silicates, aluminum silicate hydroxide, porcelain, lime, iron oxide, magnesia, alumina, nitrides, carbides, beryllias, cerias, zirconias, borides, silicides, or combinations thereof.

In some embodiments, the one or more engineering powders can comprise a metal selected from among: stainless steel, carbon, iron, cobalt, chromium, titanium, gold, calcium, phosphorous, gallium, lithium, magnesium, manganese, silver, strontium, vanadium, aluminum, tantalum, nickel, nitrogen, copper, zinc, zirconium, hafnium, niobium, yttrium, thoria, molybdenum, oxides thereof, alloys thereof, or any combination thereof.

In some embodiments, the one or more porogen materials can comprise one or more of: a salt, a sugar, a wax, a gel, a protein, a peptide, a biomaterial, a sol-gel, a rubber, alginate, a polymer, high intemal phase emulsions, polycaprolactone, calcium phosphate, thermoplastic polymers, crystals thereof, beads thereof, or combinations thereof.

In some embodiments, the one or more binder materials can comprise a polymer.

In some embodiments, the printing of the printing material into the printing space can comprise printing by layer-by-layer stacking, powder bed fusion, direction deposition technology, extrusion, injection molding, or a combination thereof.

In some embodiments, the sintering of the green part can comprise one or more of: selective layer sintering, selective laser melting, electron beam melting, direct metal laser sintering, capacitor discharge sintering, continuous mesh belt furnace sintering, electro sinter forging, pressure-less sintering, microwave sintering, spark plasma sintering, electric current assisted sintering, transient liquid phase sintering, permanent liquid phase sintering, liquid phase sintering, metallic powder sintering, hot isostatic pressing, direct current in vacuum sintering, sinter hardening, tempering, or fritting.

According to another embodiment, a non-transitory computer-readable medium can be provided that stores instructions which, when executed by a processor, cause at least the following: preparing a printing material comprising one or more engineering powders, one or more porogen materials, and one or more binder materials; printing the printing material into a printing space; and at least partially solidifying the printing material during the printing to form a green part.

In some embodiments, the non-transitory computer-readable medium can further store instructions which, when executed by the processor, cause at least the following: partially solidifying the printing material during the printing to form the green part by delivering a non-solvent vapor to the printing material during printing to cause a vapor-induced phase separation of the one or more binder materials.

In some embodiments, the non-transitory computer-readable medium can further store instructions which, when executed by the processor, cause at least the following: removing the one or more porogen materials.

In some embodiments, the non-transitory computer-readable medium can further store instructions which, when executed by the processor, cause at least the following: sintering the green part to form a sintered part by increasing a temperature of the green part from the temperature of the green part once formed to a temperature lower or greater than the melting point of one of the used components.

In some embodiments, the non-transitory computer-readable medium can further store instructions which, when executed by the processor, cause at least the following: adjusting a ratio of the one or more porogen materials to the one or more engineering powders and the one or more binder materials prior to printing the printing material into the printing space to spatially tune the porosity and/or pore size of the sintered part.

In some embodiments, the non-transitory computer-readable medium can further store instructions which, when executed by the processor, cause at least the following: at least partially coating the sintered part with a ceramic coating to form a finished part.

In some embodiments, the one or more engineering powders can comprise one or more of: a ceramic, carbon, silica, clay, sand, silt, mud, loam, a metal, kaolinite, montmorillonite, hydrous aluminum phyllosilicates, illite, vermiculite, magnesium silicates, aluminum silicate hydroxide, porcelain, lime, iron oxide, magnesia, alumina, nitrides, carbides, beryllias, cerias, zirconias, borides, silicides, or combinations thereof.

In some embodiments, the one or more engineering powders can comprise a metal selected from among: stainless steel, carbon, iron, cobalt, chromium, titanium, gold, calcium, phosphorous, gallium, lithium, magnesium, manganese, silver, strontium, vanadium, aluminum, tantalum, nickel, nitrogen, copper, zinc, zirconium, hafnium, niobium, yttrium, thoria, molybdenum, oxides thereof, alloys thereof, or any combination thereof.

In some embodiments, the one or more porogen materials can comprise one or more of: a salt, a sugar, a wax, a gel, a protein, a peptide, a biomaterial, a sol-gel, a rubber, alginate, a polymer, high intemal phase emulsions, polycaprolactone, calcium phosphate, thermoplastic polymers, crystals thereof, beads thereof, or combinations thereof.

In some embodiments, the one or more binder materials can comprise a polymer.

In some embodiments, the printing of the printing material into the printing space can comprise printing by layer-by-layer stacking, powder bed fusion, direction deposition technology, extrusion, injection molding, or a combination thereof.

In some embodiments, the sintering of the green part can comprise one or more of: selective layer sintering, selective laser melting, electron beam melting, direct metal laser sintering, capacitor discharge sintering, continuous mesh belt furnace sintering, electro sinter forging, pressure-less sintering, microwave sintering, spark plasma sintering, electric current assisted sintering, transient liquid phase sintering, permanent liquid phase sintering, liquid phase sintering, metallic powder sintering, hot isostatic pressing, direct current in vacuum sintering, sinter hardening, tempering, or fritting.

According to another embodiment, a system can be provided that comprises: a first reservoir storing a first printing material, the first printing material comprising first inorganic particles, a first sinterable material, a first binder material, and a first porogen material suspended in a first solvent; a second reservoir storing a second printing material, the second printing material comprising second inorganic particles, a second sinterable material, a second binder material, and a second porogen material suspended in a second solvent; a printing nozzle disposed within a printing space, the printing nozzle being in fluidic communication with the first reservoir and the second reservoir and configured to receive a volume of the first printing material and a volume of the second printing material, the printing nozzle being configured to dispose a mixture of the first and second printing materials into the printing space during a printing period; a vapor dispersion apparatus in fluidic communication with the printing space and configured to disperse a volume of a nonsolvent vapor into the printing space during the printing period to form a green part from the mixture of the first and second printing materials by at least partially solidifying the mixture of the first and second printing materials in the printing space; and a computing device configured to cause printing of the first and second printing materials into the printing space during the printing period, wherein causing printing comprises causing movement of the printing nozzle along a predetermined pathway through the printing space, causing the printing nozzle to dispose portions of the first and second printing materials into the printing space and along the predetermined pathway during the printing period, and causing the vapor dispersion apparatus to disperse the volume of the nonsolvent vapor into the printing space during the printing period.

In some embodiments, the system can further comprise: a coagulation bath configured to receive the green part after the at least partial solidification of the mixture of the first and second printing material, the coagulation bath configured to fully solidify the green part.

In some embodiments, the system can further comprise: a porogen leaching bath configured to receive the green part after the at least partial solidification of the mixture of the first and second printing material, the porogen leaching bath configured to remove substantially all of the first porogen material and the second porogen material from the green part.

In some embodiments, the system can further comprise: a sintering apparatus configured to sinter the green part at a temperature lower or greater than the melting point of one of the included components, forming a sintered part.

In some embodiments, the system can further comprise: a ceramic coating apparatus configured to dispose a ceramic material onto at least a portion of an outer surface of the sintered part.

In some embodiments, the one or more engineering powders can comprise one or more of: a ceramic, carbon, silica, clay, sand, silt, mud, loam, a metal, kaolinite, montmorillonite, hydrous aluminum phyllosilicates, illite, vermiculite, magnesium silicates, aluminum silicate hydroxide, porcelain, lime, iron oxide, magnesia, alumina, nitrides, carbides, beryllias, cerias, zirconias, borides, silicides, or combinations thereof.

In some embodiments, the one or more engineering powders can comprise a metal selected from among: stainless steel, carbon, iron, cobalt, chromium, titanium, gold, calcium, phosphorous, gallium, lithium, magnesium, manganese, silver, strontium, vanadium, aluminum, tantalum, nickel, nitrogen, copper, zinc, zirconium, hafnium, niobium, yttrium, thoria, molybdenum, oxides thereof, alloys thereof, or any combination thereof.

In some embodiments, the one or more porogen materials can comprise one or more of: a salt, a sugar, a wax, a gel, a protein, a peptide, a biomaterial, a sol-gel, a rubber, alginate, a polymer, high intemal phase emulsions, polycaprolactone, calcium phosphate, thermoplastic polymers, crystals thereof, beads thereof, or combinations thereof.

In some embodiments, the one or more binder materials can comprise a polymer.

In some embodiments, the printing of the printing material into the printing space can comprise printing by layer-by-layer stacking, powder bed fusion, direction deposition technology, extrusion, injection molding, or a combination thereof.

In some embodiments, the sintering of the green part can comprise one or more of: selective layer sintering, selective laser melting, electron beam melting, direct metal laser sintering, capacitor discharge sintering, continuous mesh belt furnace sintering, electro sinter forging, pressure-less sintering, microwave sintering, spark plasma sintering, electric current assisted sintering, transient liquid phase sintering, permanent liquid phase sintering, liquid phase sintering, metallic powder sintering, hot isostatic pressing, direct current in vacuum sintering, sinter hardening, tempering, or fritting.

In some embodiments, once the green part is sintered, the sintered part can be coated with a ceramic coating. The ceramic coating can improve the biocompatibility of the part, such as for bone tissue engineering applications. In some embodiments, microbes can be used for microbially induced mineralization, which can comprise the formation of mineral(s) on one or more surfaces of the sintered part. In some embodiments, the ceramic coating can be formed by biomineralization of calcium carbonates or other mineral coatings using bacteria, such as prokaryotic bacterial, ureolytic bacteria, cyanobacteria, photosynthetic bacterial, sulfate reducing bacterial, urea hydrolyzing bacteria, bacteria that ammonify amino acids, bacteria that reduce nitrates, bacteria that form calcium carbonates from organic acids, combinations thereof, and/or the like. In some embodiments, the biomineralization process can be carried out by or with enzymes, proteins, microbes, bacteria, other microorganisms, combinations thereof, and/or the like. In some embodiments, the biomineralization process can form micro- and/or nano-structures on the outer surface of the porous sintered part. In some embodiments, such micro-and/or nano-structures on the outer surface of the porous sintered part can increase the surface area for bone tissue formation on the porous sintered part. In some embodiments, calcium derivatives, such as calcium phosphate and calcium carbonate, can be formed on surface(s) of the sintered part by microbially-induced calcium derivative precipitation.

### BRIEF DESCRIPTION OF THE FIGURES

Having thus described the invention in general terms, reference will now be made to the accompanying drawings. The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 illustrates a process flow diagram of a method for three-dimensional (3D) printing engineered parts, according to an embodiment of the present disclosure.

FIG. 2 illustrates a schematic illustration of an apparatus for 3D printing engineered parts, according to an embodiment of the present disclosure.

FIG. 3 illustrates a schematic of an example computing device configured to 3D print according to any of the approaches or methods of the present disclosure.

FIG. 4 illustrates a schematic of an example computing device configured to 3D print according to any of the approaches or methods of the present disclosure.

FIG. 5 illustrates a process flow diagram of a method of 3D printing engineered parts, according to an embodiment of the present disclosure.

FIG. 6 illustrates a process flow diagram of a method of 3D printing engineered parts, according to an embodiment of the present disclosure.

FIG. 7 illustrates a process flow diagram of a method of 3D printing engineered parts, according to an embodiment of the present disclosure.

FIG. 8 illustrates a process flow schematic of an example apparatus for 3D printing of engineered parts, according to an embodiment of the present disclosure.

FIGS. 9A-9C illustrate a 3D printed scaffold structure having intra-filament porosity, according to an embodiment of the present disclosure.

FIG. 10A-10C illustrate a cell growth progression on a 3D printed scaffold structure having intra-filament porosity, according to an embodiment of the present disclosure.

FIGS. 11A-11B illustrate a 3D printed scaffold having an intra-filament porosity, according to an embodiment of the present disclosure.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

Various embodiments of the present disclosure will now be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

As used herein, the terms “instructions,” “file,” “designs,” “data,” “content,” “information,” and similar terms may be used interchangeably, according to some example embodiments of the present invention, to refer to data capable of being transmitted, received, operated on, displayed, and/or stored. Thus, use of any such terms should not be taken to limit the spirit and scope of the disclosure. Further, where a computing device is described herein to receive data from another computing device, it will be appreciated that the data may be received directly from the other computing device or may be received indirectly via one or more computing devices, such as, for example, one or more servers, relays, routers, network access points, base stations, and/or the like.

As used herein, the term “computer-readable medium” refers to any medium configured to participate in providing information to a processor, including instructions for execution. Such a medium may take many forms, including, but not limited to a non-transitory computer-readable storage medium (for example, non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, and infrared waves. Signals include man-made transient variations in amplitude, frequency, phase, polarization, or other physical properties transmitted through the transmission media. Examples of non-transitory computer-readable media include a floppy disk, a flexible disk, hard disk, magnetic tape, any other non-transitory magnetic medium, a compact disc read only memory (CD-ROM), compact disc compact disc-rewritable (CD-RW), digital versatile disc (DVD), Blu-Ray, any other non-transitory optical medium, punch cards, paper tape, optical mark sheets, any other physical medium with patterns of holes or other optically recognizable indicia, a random access memory (RAM), a programmable read only memory (PROM), an erasable programmable read only memory (EPROM), a FLASH-EPROM, any other memory chip or cartridge, a carrier wave, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments. By way of example only, a design file for a printed article may be stored on a computer-readable medium and may be read by a computing device, such as described hereinbelow, for controlling part or all of a three-dimensional (3D) printing process and associated apparatuses and components, according to various embodiments described herein.

As used herein, the term “circuitry” refers to all of the following: (a) hardware-only circuit implementations (such as implementations in only analog and/or digital circuitry); (b) to combinations of circuits and computer program product(s) comprising software (and/or firmware instructions stored on one or more computer readable memories), such as (as applicable): (i) to a combination of processor(s) or (ii) to portions of processor(s)/software (including digital signal processor(s)), software, and memory(ies) that work together to cause an apparatus, such as a mobile phone or server, to perform various functions described herein); and (c) to circuits, such as, for example, a microprocessor(s) or a portion of a microprocessor(s), that require software or firmware for operation, even if the software or firmware is not physically present. This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, other network device, and/or other computing device.

As used herein, the term “computing device” refers to a specialized, centralized device, network, or system, comprising at least a processor and a memory device including computer program code, and configured to provide guidance or direction related to the charge transactions carried out in one or more charging networks.

As used herein, the terms “about,” “substantially,” and “approximately” generally mean plus or minus 10% of the value stated, e.g., about 250 μm would include 225 μm to 275 μm, about 1,000 μm would include 900 μm to 1,100 μm. Any provided value, whether or not it is modified by terms such as “about,” “substantially,” or “approximately,” all refer to and hereby disclose associated values or ranges of values thereabout, as described above.

In bone tissue engineering, various 3D structures can be engineered as scaffolding for growing bone tissue to make bone grafts/implants, including bioceramic-containing and metallic-containing implants. A bone graft/implant can have osteoconductivity to promote bone apposition, osteogenicity to contain osteoprogenitor cells, and osteoinductivity to provide signals to induce osteogenic differentiation of local stem cells while avoiding the stress-shielding effect.

An effective implant aims at restoring the function of bone and promoting regeneration of bone tissue at the damaged site by acting as a bone scaffold. As such, effective bone grafting/implantation often calls for multi-scale porous scaffolds made from bioceramics or coated with micro-and nano-structured bioceramics to mimic the physiological anatomy of natural bones.

In particular, the incorporation of porosity into bone implants has been of great interest for better osseointegration likelihood. Physiologically speaking, human bones are naturally porous: compact bones (cortical bones) have ˜3-5% of spaces while trabecular bones (cancellous bones) have approximately 50-90% porosity. It has been hypothesized that increasing porosity is expected to improve osteogenesis and osseointegration. Especially, the integration of pores is essential for the formation of bone tissue by allowing osteoblasts and mesenchymal cells to migrate and to proliferate to improve neovascularization for cellular activity-related mass transport. At the same time, pores may provide more space for new bone tissue to grow while providing the necessary support for cells to maintain their differentiated functions and structures. Furthermore, a porous surface enhances the mechanical interlocking (interdigitation) between the implant and surrounding natural human bone to provide increased mechanical stability at the interacting junction.

There is no consensus on the optimal porosity and pore size while the overall optimal range overlaps with the findings from different studies. For example, the optimal porosity of an implant efficiently stimulating bone ingrowth is reported in the range of 20-50% with a pore size of 100-400, while the 60% porosity and a pore size range of 200-1200 μm are also reported as required for better bone tissue ingrowth. On the other hand, some extreme ranges (porosity of 75-85% and pore size of 500-1500 μm) are observed to be optimal for bone tissue ingrowth. For better osseointegration performance, multi-scale porosity and pore size is expected for different bone regeneration purposes for different bones. Generally, smaller pores are better for osteoblast cell attachment, protein adsorption, and bone regeneration (osteochondral ossification), while larger pores favor osteogenesis due to the increased space that allows for more vascularization and oxygenation that leads to higher long-term cell proliferation and viability.

While there are commercially available highly porous metallic parts (up to 80%) formed by interconnected dodecahedron pores (average size 550 m) and manufactured by Zimmer (Warsaw, Indiana, USA), the pores of bone implants are typically introduced in two different approaches. The first approach is to tune the geometry of lattice structures by adjusting the printing conditions and/or controlling the strut size, which usually results in pores often larger than 500 m and dense columns. The second approach is to apply a powder metallurgy route using a wide variety of sacrificial pore formers (SPFs). However, the reliance on processes of pyrolysis or acid leaching to remove SPF(s) may raise material compatibility issues and limit the material selection for bone implants. In addition, it is difficult to spatially control the multi-scale porosity and pore size across the entire implant. As such, it is expected that a bone implant should have multi-scale porosity and pore size, which cannot be readily realized using the available fabrication technologies.

Thus, the inventors have conceived of and diligently reduced to practice multiple embodiments of a system, method, compositions of matter, and apparatus for three-dimensional (3D) printing that enables freeform fabrication of multi-material structures having tunable porosity.

Described are methods for printing multi-material parts with spatially tunable porosity and pore size, in particular, for bone tissue engineering applications. This process utilizes the vapor-induced phase inversion mechanism to have in situ solidification of binder material(s) by delivering a non-solvent vapor to the structure being printed from a mixed powder suspension. The porous features are defined by the inter-filament spacing and the intra-filament pores, being such intra-filament porosity the result of the use of sacrificial porogen material. The densification of the printed parts is obtained via solid-state sintering. For bone tissue engineering applications, the printed parts can be further processed via microbially-induced deposition of a calcium derivative, such as calcium phosphate or calcium carbonate, on the outer surface of the porous, 3D printed part.

According to some embodiments, the printing approach can include additive manufacturing. 3D printing, or freeform fabrication approaches. For example, freeform fabrication can be carried out under ambient conditions and without the use of printed support structures or the like. The printing material, also called ink or build material herein, can include particles/powders of one or more metal materials and/or one or more ceramic materials. According to these and/or other embodiments, freeform fabrication can be carried out without the use of support structures (e.g., printed support structures, solid support structures, support structures that are inherent to the printed article or the printing platform, support structures that should or must be removed after printing and before the printed article is ready for use, and/or the like). According to some embodiments, a build material or printing material (e.g., comprising one or more metal or ceramic powders, one or more ceramic powders, one or more binder materials, one or more porogen materials, one or more solvents, and/or one or more additives) can be prepared for printing according to a variety of possible printing methods (e.g., extrusion, injection, etc.) within an air-filled volume.

Examples of polymer-based additive manufacturing techniques are described in more detail in U.S. patents application Ser. Nos. 17/200,284, U.S. Patent Publication No. US20210237340A1, and U.S. Pat. No. 10,974,441, the entire contents of each of which are hereby incorporated herein by reference in their entireties for all purposes. Examples of metallic powder-based additive manufacturing techniques are described in more detail in International Patent Publication No. WO2021202261A1, the entire contents of which are hereby incorporated herein by reference in their entireties for all purposes. However, the additive manufacturing approaches described in the application, publications, and patent incorporated by reference above describe approaches for forming non-porous articles that are not suitable as scaffolds for bone tissue engineering applications. Accordingly, described herein are additive manufacturing approaches that utilize porogens, which are sacrificial materials that are leached from a green article before sintering in order to form a tunable, spatial porosity, which increases the micro-scale surface area of the printed part and increases the opportunity for bone tissue growth prior to transplantation into a patient, among other benefits. While the embodiments provided herein are primarily drawn to bone tissue engineering applications, the additive manufacturing of porous articles can be beneficial in other applications and technical fields, such as absorbents, filtration materials, oil/gas cracking catalysts, enzymatic reaction catalysts, isolation and analysis of genetic material, biofiltration tower media, gas exchange and mixing, printing applications, gas storage and sensing, and the like.

In some embodiments, an approach is provided for printing 3D green parts or green parts from a build material comprising one or more sacrificial binder material-containing powder suspensions and solidified based on the phase inversion of the sacrificial binder material(s). According to some embodiments, the printed green parts can be further sintered to for finished parts while burning away the sacrificial binder material(s). In some embodiments, a printing approach is provided in which a sacrificial material (e.g., one or more polymeric materials) is used in the build material such that the build material can be directly printed to form the green part at room temperature. In some embodiments, the green part or green parts can then be processed (e.g., thermally, chemically, radiologically, physically, via other suitable approaches, or combinations thereof) to remove the one or more polymeric materials and/or to sinter the metallic/ceramic powders to form the finished article or part.

In some embodiments, the build material can be produced by mixing metallic powders or ceramic powders with a polymeric solution, the polymeric solution comprising one or more polymeric materials disposed or dissolved in one or more solvents. In some embodiments, the one or more polymeric materials may function as a binder for the one or more metal or ceramic powders and may act as a sacrificial material to be removed after green body formation and before or during sintering. In some embodiments, the build material is then printed into an air-filled printing space to form a 3D part. In some embodiments, one or more nozzles can be used to dispose or print the build material into the printing space at one or more particular points corresponding to a respective portion of a digital design of the part or article being printed. In some embodiments, a dispensing mechanism such as extrusion or ink-jetting nozzles may be used to print the build material into the printing space. In some embodiments, before, during, and/or after printing the build material, one or more non-solvent vapors (e.g., comprising a non-solvent agent) can be delivered to the part being printed (e.g., at or nearby the point within the printing space in which the building material is being printed). Without wishing to be bound by any particular theory, upon exposure of the printed, liquid build material to the one or more non-solvent vapors, the build material may become at least partially solidified at least in part due to a reaction between and/or an exchange of the one or more non-solvent vapors with the one or more solvents, which may result in the cross-linking and/or coagulation of the one or more polymeric materials. Once partially or fully solidified, the build material will retain the shape, size, position, and orientation as printed and the one or more nozzles can be moved further along a predetermined path of travel within the printing space and continue to be used to print other portions of the build material into the printing space at other points that correspond to other portions of the digital design for the part or article. Once all portions of the part or article are printed and the one or more non-solvent vapors are used to at least partially solidify each portion of the part or article, the green part is formed, the green part being substantially durable against deformation due to normal handling or moving of the green part, gravitational forces, loss due to evaporation or vaporization of solvents or other materials within the green part, and/or the like. In some embodiments, the green part may be only partially solidified, in which case further non-solvent vapors can be delivered to the green part or the green part can be submerged or partially submerged in a coagulation bath or the like in order to fully or substantially fully solidify the green part. In some embodiments, the green part can have dimensions and a form factor that is similar to, an engineered relationship with, is substantially equal to, or is equal to the dimensions and form factor of the desired finished part or article, according to the digital design. In some embodiments, the green part may be engineered to be larger than or have a form factor that is intentionally different from the finished part or article in order to take into account an estimated, predicted, or known reduction in one or more dimensions and/or a change in part or all of the form factor of the green part relative to the finished metal structure, article, or part, due to the removal of binder materials and/or the like during sintering.

In some embodiments, since the build material is prepared as a suspension, various metal or ceramic powders can be easily mixed at different ratios in situ and controllably deposited for parts with a functional gradient as designed. In some embodiments, the non-solvent may extract some or all of the solvent away from the green part due to a higher Hansen chemical solubility or affinity with the solvent and can then partially or fully solidify the green part based on a phase inversion mechanism of the one or more polymeric materials. In some embodiments, the printed part can be further processed as needed in a coagulation bath for complete solidification as a green part. In some embodiments, at this stage, the partially or fully solidified one or more polymeric materials may act as a binding agent for the one or more metal or ceramic powders (also referred to herein as “metal particles”). In some embodiments, the consumed solvent can be reclaimed for recycling and reuse. In some embodiments, the printed green part can be heated up to the sintering temperature of the one or more metallic powders to remove the sacrificial binder (e.g., one or more polymeric materials) and sinter the metallic powders to make the final metal part, structure, or article.

Described hereinbelow are examples in which different single metal or ceramic powders, such as iron, copper, nickel, silver, and the like, were printed to form a 3D article by mixing each of them with a solution prepared from a sacrificial polymer (e.g., acrylonitrile-butadiene-styrene (ABS)) and a solvent (e.g., dimethyl sulfoxide (DMSO)) as example components of an example build material. In some embodiments, metal-ABS-DMSO build material was extruded in air to fabricate continuous conduits, shells, and bulky parts for demonstration purposes. During printing, water was used as an example non-solvent for the metal-ABS-DMSO build material and was delivered to filaments being deposited using a nebulizer in an enclosed chamber where the extracted solvent was reclaimed. After printing, the semi-solidified part was submerged in a water-based coagulation bath for complete solidification and the residual solvent was reclaimed from the bath through a distillation process. The printed parts were then sintered under proper heating cycles according to the different example metal or ceramic powders used. According to various examples, metal parts were 3D printed by using a dissolved sacrificial polymer binder and metal or ceramic powder suspension as a printing platform while a non-solvent agent was simultaneously or nearly simultaneously delivered to form a green part (also described herein as “green part,” “green article,” or “green structure), allowing an in-air metal printing process that is quicker, safer for users, more energy efficient, requires less post processing, and results in mechanically superior printed metal parts, structures, and articles. In some embodiments, the green part was subjected to a sintering cycle to burn away the binding agent and sinter the metal particles, fusing them together and obtaining a fully metallic part. In some embodiments, part shrinkage and porosity during sintering were pre-compensated during the part design phase. In some embodiments, more than a single binder polymer may be used to minimize the possible porosity by removing them sequentially (e.g., at different times during the temperature ramping period due to the different binder polymers having different vaporization temperatures) during the post-processing phase.

Herein we describe a novel implementation method for printing multi-material parts with spatially tunable porosity and pore size, in particular, for bone tissue engineering applications. This process utilizes the vapor-induced phase inversion mechanism to have in situ solidification of binder material(s) by delivering a non-solvent vapor to the structure being printed from a mixed powder suspension. The porous features are defined by the inter-filament spacing and the intra-filament pores, being such intra-filament porosity the result of the use of sacrificial porogen material. The densification of the printed parts is obtained via solid-state sintering. For bone tissue engineering applications, the printed parts can be further processed via microbially-induced deposition of a calcium derivative, such as calcium phosphate or calcium carbonate, on the outer surface of the porous, 3D printed part.

This technology disclosure describes a novel approach to fabricate three-dimensional (3D) multi-material structures with tunable multi-scale porosity and pore size and a biocompatible ceramic coating, which are particularly useful for bone tissue engineering applications. Under the disclosed technology, green parts are first printed from binder-based powder suspensions, which may include any engineering material powders, sinterable additives, and/or porogens, and the ratio of these compositions in the suspensions can be controlled by a mixer right before printing. The green parts are partially solidified based on the vapor-induced phase inversion of the binder material(s) to retain the shape of printed structures. After the printing process is finished, the green parts are immersed in a coagulation bath for complete solidification. The porogen, if any, is then removed using a proper physical or chemical mechanism, such as dissolving a sodium chloride-based porogen by immersing the part in water in order to produce porous parts. The printed porous green parts are further sintered for part densification, and the binder may or may not be burned away. The porous features of the part are spatially tunable by the arrangement of the printing path to have inter-filament macroscale porosity and pore size (typically on the order of 500-1000 μm), as well as by the selection of the percentage and size of the embedded porogen material in each printed filament (typically on the order of 50-150 μm). The resulting multi-scale pore size helps the osseointegration performance of the printed parts if used as medical implants. Their resulting overall porosity also yields adjustable mechanical properties, which is especially of interest in the biomedical implant field to minimize the influence of the stress shielding effect. Additional microbially-induced calcium-derivative precipitation can be carried out as a post-processing step to further coat a calcium-based bioceramic layer with micro-and nano-structures on the outer surface across all the porous space.

To illustrate the feasibility of the proposed printing technology, multi-scale porous parts are printed using stainless steel (316L), salt (NaCl) particles (porogen), acrylonitrile-butadiene-styrene (ABS) (polymeric binder), solvent (dimethyl sulfoxide (DMSO)), and water (non-solvent for ABS and solution for NaCl). In addition, 316L-hydroxyapatite (HAp) composites are printed to showcase the versatility of the disclosed printing technology.

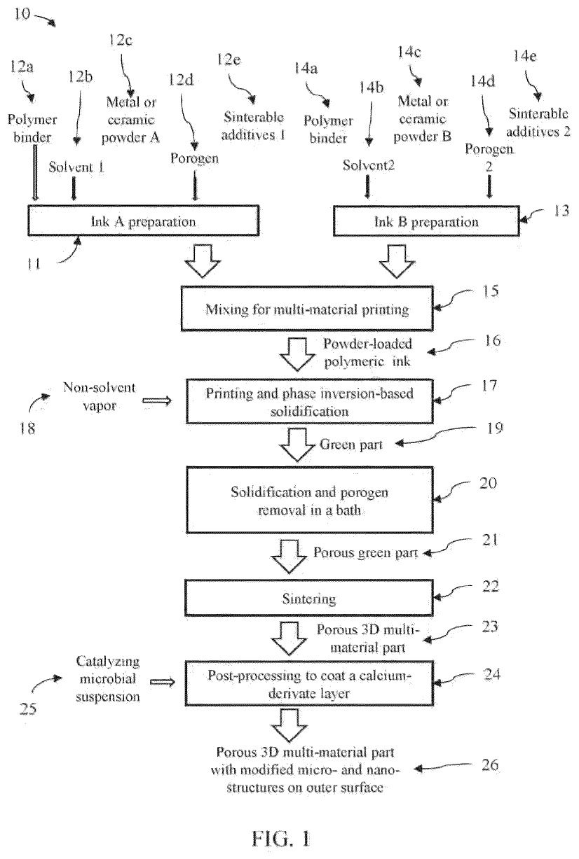

Referring now to FIG. 1, a 3D printing process 10 for fabricating multi-material parts is provided, which includes three or more steps, including for example: powder ink preparation, freeform printing, phase inversion-based solidification, porogen removal, sintering, and post-sintering ceramic coating. While the one or more polymers are illustrated and/or described generally as being the binder/sacrificial materials in FIG. 1, other soluble binder materials can be used as sacrificial materials too, e.g., waxes, lower melting point metals, etc. According to some embodiments, the 3D printing process 10 comprises preparation of a first ink 11 by combining one or more first polymers 12a, one or more first solvents 12b, one or more first metal or ceramic powders 12c, one or more first porogen materials 12d. and, optionally, one or more first sinterable additives 12e. The 3D printing process 10 can further comprise, optionally, preparation of a second ink 13 by combining one or more second polymers 14a, one or more second solvents 14b, one or more second metal or ceramic powders 14c, one or more second porogen materials 14d, and, optionally, one or more second sinterable additives 14e. In some embodiments, the mentioned mixture description serves the purpose of illustration of the multi-material capabilities of the proposed process, and it does not intend to limit the mixing method uniquely to two inks, as the described approach can be used to mix simultaneously more than two ink compositions.

In some embodiments, forming the ink or build material can involve mixing 15 metal or ceramic powders (e.g., 12c or 14c) with a respective polymer solution, which is prepared by dissolving one or more polymeric materials in one or more suitable solvents (e.g., the one or more first polymers 12a in the one or more first solvents 12b, or the one or more second polymers 14a in the one or more second solvents 14b, respectively) in order to obtain a homogeneous powder ink suspension for printing. In some embodiments, first one build material (e.g., A) and then the other build material (e.g., B) can be printed to form different portions of the printed article. In other embodiments, the 3D printing process 10 can further comprise, optionally, mixing 15 two or more build materials (inks) together to form a multi-metal printing material 16, also called a powder-loaded polymeric ink. In some embodiments, two or more different build materials (e.g., A and B) can be prepared and then combined according to any suitable ratio in order to achieve a specific composition to print a particular portion of the green part such that the corresponding portion of the finished metal article, part, piece, or structure likewise has a corresponding ratio of a first and second (or more) metal particles. In such a manner, one or more particular portions of the finished article, or all of the finished article, can comprise a binary, ternary, quaternary, quintenary, or other such metal composition. In some embodiments, a desired powder ink suspension containing different metal or ceramic powders (e.g., A and B) can be prepared by mixing them at a given ratio by changing the mixing inputs from each starting ink.

In some embodiments, the 3D printing process 10 can further comprise printing and phase inversion-based solidification 17 the build material (e.g., A or B), or the multi-metal printing material 16. In some embodiments, an applicable dispensing mechanism, such as material extrusion or material jetting, can be used to dispense the ink(s) or building material(s) into a printing space according to a layer-by-layer deposition approach or any other suitable approach, e.g., having an article building block of a material filament, a material droplet, or the like. In some embodiments, printing and solidifying 17 can be carried in an enclosed chamber to collect any released solvent and to minimize user exposure to the materials or process and to reduce contamination or detrimental external or environmental impacts on printing quality. In some embodiments, during printing and solidifying 17, a non-solvent vapor 18 can be delivered to the location, space, position, environment, or sub-volume of the enclosed chamber where the metal-polymer composite part is being printed. In some embodiments, the non-solvent vapor 18 may solidify or partially solidify some or all of the polymer(s) in the build material (e.g., A, B, or 16) to retain deposited features and thereby entrap the metal or ceramic powders distributed in the deposited building block.

In some embodiments, the printing and solidification process 17 may be known as phase inversion in instances in which solidification is based on or includes the phase separation of a homogeneous polymer solution in a non-solvent medium in which the polymer does not dissolve and with which the solvent in the solution is fully miscible. In some embodiments, as the polymer non-solvent and polymer solvent present higher Hansen solubility than the Hansen solubility exhibited between the polymer and the solvent, the non-solvent, if properly chosen according to the particular polymer(s) and solvent(s) chosen, may have sufficient affinity to replace the solvent within the polymer solution. As such, in some embodiments, the rate at which phase inversion occurs may highly depend on the degree of solubility of the solvent in the non-solvent and the insolubility of the polymer in the non-solvent. In some embodiments, a similar principle may hold for systems in which more than one polymer, more than one solvent, and/or more than one non-solvent (also described herein as a “coagulation agent”) are used. In some embodiments, the phase inversion process may be induced, at least in part, by depositing the ink in a non-solvent-rich environment or disposing/deploying non-solvent or coagulation agent material nearby the printed or deposited ink.

In some embodiments, the phase inversion process may begin at or near an outer surface of deposited filaments/droplets when in contact with the active non-solvent agent in the printing environment. In some embodiments, once the surface is partially or fully solidified, a coagulation front may travel inwards within each filament/droplet of printed build material/ink, e.g., through diffusion of the non-solvent through each filament/droplet, and may extract some or all of the solvent from respective filaments/droplets of the printed structure. In some embodiments, this simultaneous or nearly simultaneous solidification of build material concurrent with printing of the build material may be controlled in such a way that solidification occurs only partially, e.g., in order to achieve a balance between achieving sufficient fusion between adjacently deposited layers, filaments, or droplets, due to the build material not being fully deposited, and achieving sufficient stiffness to support subsequently printed layers in air due to the existence of previously solidified or partially solidified build material (e.g., the one or more polymeric materials in the build material of a first layer may be coagulated or solidified enough such that a second layer of build material can be deposited on or supported on or stabilized by the first layer of build material). In some embodiments, through such phase inversion and other coagulation/solidification approaches, the 3D printing process 10 can further comprise formation of a green part 19 (also referred to herein as “green part”).

In an instance in which the green part 19 is only partially coagulated or solidified through exposure to the one or more coagulation agents/non-solvents, further coagulation or solidification may be necessary before the green part 19 is ready for post-printing processing. In some embodiments, in order to achieve complete or nearly complete solidification throughout a printed part, the green part 19 can be immersed, if needed, in a coagulation bath to fully remove the solvent. In some embodiments, the collected solvent-relevant solution from the printing chamber and coagulation bath are post-processed in order to reclaim the solvent for its reuse, minimizing its environmental impact. In some embodiments, variable metal or ceramic powder suspensions can be mixed, prior to printing, to achieve a desired composition, and can be controllably deposited as a composition gradient structure during the printing and solidification process 17. Said otherwise, in some embodiments, the ratio of a first and second build material (or a first, second, and third build material, etc.) can be changed dynamically during the printing and solidification process 17 such that a composition of the green part 19 achieves a compositional gradient between two locations, portions, regions, or sub-parts of the green part 19.

In some embodiments, the 3D printing process 10 can further comprise, optionally, depositing the green part 19 into a solidification and porogen removal bath 20 to further/fully solidify the one or more first polymers 12a and the one or more second polymers 14a, and to leach sacrificial material(s), such as the one or more first porogen materials 12d and/or the one or more second porogen materials 14d. Depositing the green part 19 into the solidification/porogen removal bath 20 forms a porous green part 21.

In some embodiments, the 3D printing process 10 can further comprise sintering 22 the green part 19 according to a suitably high temperature sintering cycle chosen from among a plurality of suitable sintering cycles according to the metal or ceramic powder(s) used in the green part 19, to form a porous 3D multi-material part 23. In some embodiments, the sintering 22 can comprise a binder/polymer removal process at lower temperatures than the sintering level. In some embodiments, the binder/polymer removal process (also referred to herein as “binder burnout process”) can be carried out to melt, decompose, vaporize, and/or evaporate the binder(s)/polymer(s) from the green part 19. In some embodiments, the binder burnout process must be carefully designed and controlled in order to avoid disruption of the macro structures of the printed part and/or the intra-/inter-metal particle fusing, ordering, structure, crystallization, etc. In some embodiments, the sintering 22 can occur at sufficiently high temperatures that are below the melting point of the metal or ceramic powder or metal or ceramic powders.

In some embodiments, the 3D printing process 10 can further comprise post-processing the porous 3D multi-material part 23 by applying a coating 24 to at least a portion of the porous 3D multi-material part 23, such as a coating comprising a calcium-derivate. In some embodiments, the 3D printing process 10 can further comprise catalyzing a microbial suspension 25 on the porous multi-material part 23 after being coated 24, which forms modified micro- and nano-structures on an outer surface of the porous multi-material part 26.

In some embodiments, the sintering 22 can be carried out at temperatures close to the melting point of one of the included components (as an example of about 1,000° C.), or other suitable temperatures, depending on the composition of the printing materials. Without wishing to be bound by any particular theory, at such temperatures, the metal particles may start to fuse with each other due to atomic diffusion, as the atoms can move easily and migrate quicker along the particle-particle interfaces and inter-particle contact surfaces. Without wishing to be bound by any particular theory, at least some of the mechanisms that may contribute to sintering of a consolidated mass of crystalline particles are surface and grain boundary diffusion, which may be heavily dependent on the particle size and the material properties, and vapor transport and plastic flow, which entails the capability of the metal to permeate the gases obtained from the sintering process and which may impact the resulting porosity of the sintered metal part. In some embodiments, residual porosity may be found in powder metallurgy fabricated parts on the order of between about 1% and about 5%, however any suitable porosity can be achieved and is therefore contemplated as part of this disclosure. In some embodiments, the specifications of the thermal sintering cycle may depend on the binding polymers and metal or ceramic powder(s) used, as well as the dimensions and/or form factor of the printed structure. In some embodiments, after sintering and taking into account the porous nature of the resulting part, the porous printed part can be, if needed, further infiltrated with suitable materials to ensure the pores are further filled, partially filled, nearly fully filled, or fully filled. In addition to the porosity, 3D printed metal parts may experience shrinkage during sintering. As such, the design, dimensions, and form factor for the green part 18 can be pre-compensated during the part design phase such that the sintered metal part adheres to the desired form factor and dimensions after the accounted-for sintering-induced shrinkage. In particular, in some embodiments, different binder polymers may be used to minimize the possible porosity by removing them sequentially during the post-processing phase.

In some embodiments, a system can be provided for carrying out the 3D printing process 10. In some embodiments, such a system may comprise an enclosed printing space, one or more printing nozzles, one or more non-solvent vapor delivery elements, one or more reservoirs configured to store a supply of one or more build materials, and a computing entity configured to: load and interpret a digital design of the green part 19, control movement of the printing nozzles, deliver build material via the printing nozzles, move the one or more non-solvent vapor delivery elements, deliver non-solvent vapor via the one or more non-solvent vapor delivery elements, and the like. In some embodiments, the system can further comprise a coagulation bath into which the green part 19 can be at least partially submerged in an instance in which the build material only partially or insufficiently solidifies during the interaction between the solvent and non-solvent vapor. In some embodiments, the system can further comprise a sintering oven operable to control a temperature, change in temperature, pressure, humidity, and/or other characteristics and parameters of an inner volume of the sintering oven. In some embodiments, the green part 19 can be loaded into the sintering oven and sintered to achieve the finished, printed metal article. In some embodiments, the enclosed printing space may function as the sintering oven such that the green part 19 can be printed in air and supported on a substrate within the enclosed printing space in the presence of coagulant, and then the green part 19 can be sintered without removing the green part 19 from the inner volume of the enclosed printing space.

In some embodiments, part of the 3D printing process 10 can, optionally, comprise the formation of a design for the green part 19 that accounts for any shrinkage during sintering. In some embodiments, the 3D printing process 10 can, optionally, comprise a computer-implemented or computer-controlled printing process whereby a computing entity or the like can interpret a digital design of the green part 19, map out one or more predetermined nozzle pathways within the enclosed printing space, move or cause movement of one or more nozzles according to the one or more predetermined nozzle pathways and a deposition rate of each nozzle to adequately deposit the build material at a suitable rate with respect to each location and rate of movement of each nozzle in order to deposit the correct type and quantity of build material at each location within the printing space that corresponds with a respective portion of the green part 19. In some embodiments, the 3D printing process 10 can, optionally, comprise a computer-implemented or computer-controlled printing process whereby a computing entity or the like can determine, for each nozzle of the one or more nozzles, a ratio of different build materials when a design for the green part 19 necessitates a build material that is achieved or achievable by combining two or more prepared build materials. In some embodiments, the 3D printing process 10 can, optionally, comprise a computer-implemented or computer-controlled printing process whereby a computing entity or the like can determine, based upon the one or more predetermined nozzle pathways, one or more predetermined nebulizer pathways for delivering one or more non-solvent vapors to the printed build material simultaneously or nearly simultaneously with the printing of the respective portions of the green part 19. In some embodiments, the 3D printing process 10 can, optionally, comprise a computer-implemented or computer-controlled printing process whereby a computing entity or the like can control a temperature and a temperature ramp rate for a vaporization/burnout process and/or the sintering 22. As such, an aspect of this disclosure deals with the use of computing entities, either as part of an apparatus or system or external to the apparatus or system, to carry out these and other aspects of the 3D printing process 10, other tasks and processes described herein, the methods described and claimed, and the like.

Computer Program Products, Methods, and Computing Entities

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language, such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### Example Systems and Apparatuses

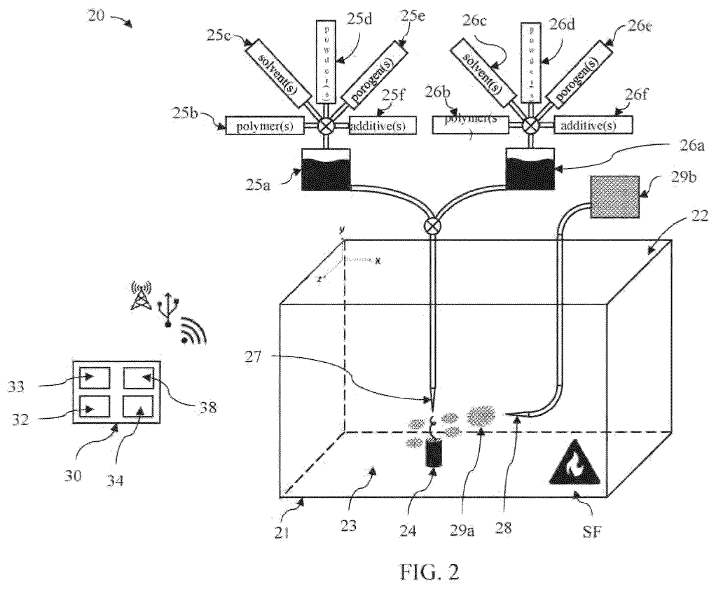

FIG. 2 provides, according to an embodiment of the present disclosure, an apparatus 20 for solvent-assisted 3D printing of metal parts at ambient temperature and pressure, without the use of a support bath or printed solid supports during printing, and without melting the polymeric material in the build material to render the build material sufficiently plastic for printing. The apparatus 20 comprises a printing environment 21, which may be enclosed or open, but nevertheless defines an inner volume 22 and comprises a printing substrate 23. The apparatus 20 can be operably configured to 3D print a self-supporting article 24 (e.g., such as the green part 19) supported on the printing substrate 23 and being self-supporting across a wide degree of article complexities. The apparatus 20 can further comprise a first ink reservoir 25a configured to store a supply of a first printing material that comprises one or more first polymers 25b, one or more first solvents 25c, one or more first powders 25d, one or more first porogen materials 25d, and one or more first additives 25f. The apparatus 20 can further comprise a second ink reservoir 26a configured to store a supply of a second printing material that comprises one or more second polymers 26b. one or more second solvents 26c, one or more second powders 26d, one or more second porogen materials 26d, and one or more second additives 26f.

In some embodiments, the first ink reservoir 25a and/or the second ink reservoir 26a can be operably coupled to a printing nozzle 27 that is dimensioned and configured to receive from the first ink reservoir 25a and/or the second ink reservoir 26a a portion or flow of the first and/or second printing materials/inks. The printing nozzle 27 can be configured to be moved in three dimensions (x, y, and z) within the inner volume 22 of the printing environment 21 and to dispose discrete volumes or continuous flows of the ink to particular locations within the inner volume 22 that are associated with the self-supporting article 24, as desired. Said otherwise, the printing nozzle 27 can be configured to dispose volumes or a flow of the ink onto the printing substrate 23 or onto a previously printed portion of the self-supporting article 24, in the inner volume 22, e.g., an air-filled inner volume, and to move in three dimensions such that particular volumes of the ink are deposited at corresponding particular points and locations such that the dimensions, form factor, and characteristics of the self-supporting article 24, once fully printed, are in line with those desired or in line with an initial design for the self-supporting article 24. To do so, the printing nozzle 27 may be configured to deposit the ink into the inner volume 22 according to a pre-determined route, pathway of travel, timeline, or printing schedule.

In some embodiments, the apparatus 20 can further comprise a vapor dispersion apparatus 28 configured to disperse a non-solvent vapor 29a within the inner volume 22 of the printing environment 21. The vapor dispersion apparatus 28 can be configured to receive a supply of the non-solvent vapor 29a from a non-solvent reservoir 29b. In some embodiments, at a predetermined time before, during, or after the printing nozzle 27 deposits the ink into the inner volume 22, e.g., according to the pre-determined route or printing schedule, the vapor dispersion apparatus 28 can be configured to nebulize a volume of the non-solvent vapor and disperse the nebulized volume of the non-solvent vapor nearby the printing nozzle 27 and/or nearby the deposited ink. In some embodiments, the predetermined time may be selected from a predetermined temporal range on either side of the time at which the ink is deposited from the printing nozzle 27 into the inner volume 22 at respective particular locations. In some embodiments, “nearby” the printing nozzle 27 or the deposited ink may refer to a location within a predetermined distance of the printing nozzle 27 or within a predetermined distance of the deposited ink. In some embodiments, the vapor dispersion apparatus 28 may be configured to disperse the non-solvent vapor 29a, once nebulized, before, during, and after deposition of the ink such that sufficient physical and chemical interaction with the deposited ink and the non-solvent vapor 29a, once nebulized, is possible. In some embodiments, the vapor dispersion apparatus 28 may be configured to move in three dimensions (x, y, and z) in concert with or alignment with the movements of the printing nozzle 27. In some embodiments, more than one nozzle, e.g., such as more than one of the printing nozzle 27, and/or more than one nebulizer, e.g., such as more than one of the vapor dispersion apparatus 28, may be concurrently used during printing, such as for printing different portions of a large or complex article, e.g., the self-supporting article 24.

In some embodiments, the apparatus 20 can comprise a sintering furnace SF element configured to increase a temperature in the inner volume 22 of the of the printing environment 21 in order to carry out debinding and/or sintering of the self-supporting article 24 following partial or full coagulation. In some embodiments, the printing nozzle 27 and vapor dispersion apparatus 28 can be removed from the inner volume 22 of the printing environment 21 and the printing environment 21 can be enclosed, and then the SF element can be caused to increase the temperature to at or above a debinding temperature and/or at or above a sintering temperature, which can be determined based upon the specific binder (e.g., polymeric) materials and metal or ceramic powders used in forming the self-supporting article 24 (e.g., the green part 19). In some embodiments, the sintering process can be carried out in separate equipment, such as a standalone sintering furnace or the like.

In some embodiments, the apparatus 20 may comprise or be in communication with a computing device 30 that is operable to cause or control one or more of the movements of the printing nozzle 27, the provision of ink from the first or second ink reservoirs 25a, 26a to the printing nozzle 27, the rate of deposition of ink from the printing nozzle 27, the movements of the vapor dispersion apparatus 28, the provision of the non-solvent vapor 29a from the non-solvent reservoir 29b to the vapor dispersion apparatus 28, the rate of nebulization of the non-solvent vapor 29a by the vapor dispersion apparatus 28, the rate and/or distance of dispersal of the non-solvent vapor 29a from the vapor dispersion apparatus 28, the commencement or termination of printing and/or vapor dispersion, other similar properties or activities within or about the printing environment 21, combinations thereof, and/or the like.

In some embodiments, the computing device 30 can comprise one or more processing elements 32, one or more non-volatile memories 33, one or more volatile memories 34, and/or one or more transmitter/receivers 38 (e.g., “transceivers 38”). In some embodiments, the computing device 30 is configured to store one or more computer program products, computer program code, a computer-readable media comprising instructions, and/or the like. In some embodiments, the computing device 30 is configured to determine, using a starting position, a manual input, sensors, a geospatial coordinate system, or the like, a current position of the printing nozzle 27, the vapor dispersion apparatus 28, and/or the like. In some embodiments, the computing device 30 is configured to determine, using any suitable means, a current ink level in the first and/or second ink reservoirs 25a, 26a and/or a current non-solvent level in the non-solvent reservoir 29b. In some embodiments, the computing device 30 is configured to be in wired or wireless communication, such as via the transceivers 38, with one or more motors (not shown) or the like that are configured to move the printing nozzle 27, the vapor dispersion apparatus 28, or other components of the apparatus 20 within the inner volume 22 of the printing environment 21. In some embodiments, the computing device 30 can be configured to communicate a set of instructions to the one or more motors, or the like, for a series of movements of the printing nozzle 27 within the inner volume 22 of the printing environment 21. In some embodiments, the computing device 30 can provide movement instructions to the one or more motors, or the like, for making a series or sequence of movements of the printing nozzle 27 which are necessary to print the self-supporting article 24 in its entirety. In some embodiments, the computing device 30 can provide movement instructions to the one or more motors, or the like, for making a series or sequence of movements of the vapor dispersion apparatus 28 such that the vapor dispersion apparatus 28 follows the movements of the printing nozzle 27 in order to achieve or maintain a distance between the vapor dispersion apparatus 28 and the printing nozzle 27 that is sufficient to at least partially coagulate the one or more polymeric materials in the build material as it is disposed from the printing nozzle 27. In some embodiments, the computing device 30 can provide flow rate instructions, e.g., in conjunction with movement instructions, to one or more of the first and/or second ink reservoirs 25a, 26a, the printing nozzle 27, the vapor dispersion apparatus 28, or the non-solvent reservoir 29b in order for the proper flow rate or discrete volume of first and/or second printing material or the non-solvent vapor 29a, once nebulized, is disposed or dispersed at a correct corresponding location within the inner volume 22 of the printing environment 21 such that the apparatus 20 can achieve the self-supporting article 24, as desired.

### Example Computing Entity

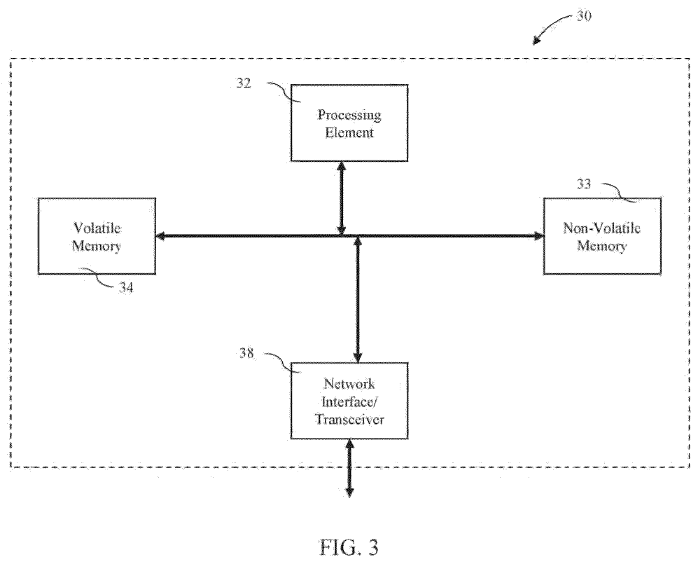

FIG. 3 provides a schematic of the computing device 30 according to one embodiment of the present invention. In general, the terms computing device, computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As shown in FIG. 3, in one embodiment, the computing device 30 may include or be in communication with one or more processing elements 32 (also referred to as processors, processing circuitry, and/or similar terms used herein interchangeably) that communicate with other elements within the computing device 30 via a bus, for example. As will be understood, the processing element 32 may be embodied in a number of different ways. For example, the processing element 32 may be embodied as one or more complex programmable logic devices (CPLDs), microprocessors, multi-core processors, coprocessing entities, application-specific instruction-set processors (ASIPs), microcontrollers, and/or controllers. Further, the processing element 32 may be embodied as one or more other processing devices or circuitry. The term circuitry may refer to an entirely hardware embodiment or a combination of hardware and computer program products. Thus, the processing element 32 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 32 may be configured for a particular use or configured to execute instructions stored in volatile or non-volatile media or otherwise accessible to the processing element 32. As such, whether configured by hardware or computer program products, or by a combination thereof, the processing element 32 may be capable of performing steps or operations according to embodiments of the present invention when configured accordingly.

In one embodiment, the computing device 30 may further include or be in communication with non-volatile media (also referred to as non-volatile storage, memory, memory storage, memory circuitry, and/or similar terms used herein interchangeably). In one embodiment, the non-volatile storage or memory may include the one or more non-volatile memories 33, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the computing device 30 may further include or be in communication with volatile media (also referred to as volatile storage, memory, memory storage, memory circuitry, and/or similar terms used herein interchangeably). In one embodiment, the volatile storage or memory may also include one or more volatile memories 34, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 32. Thus, the databases, database instances, database management systems, data, applications, programs, program modules, scripts, source code, object code, byte code, compiled code, interpreted code, machine code, executable instructions, and/or the like may be used to control certain aspects of the operation of the computing device 30 with the assistance of the processing element 32 and operating system.

In some embodiments, the computing device 30 may also include one or more network interfaces, such as a transceiver 38 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing device 30 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing device 30 may include or be in communication with one or more input elements, such as a keyboard input, a mouse input, a touch screen/display input, motion input, movement input, audio input, pointing device input, joystick input, keypad input, and/or the like. The computing device 30 may also include or be in communication with one or more output elements (not shown), such as audio output, video output, screen/display output, motion output, movement output, and/or the like.

### Example External Computing Entity

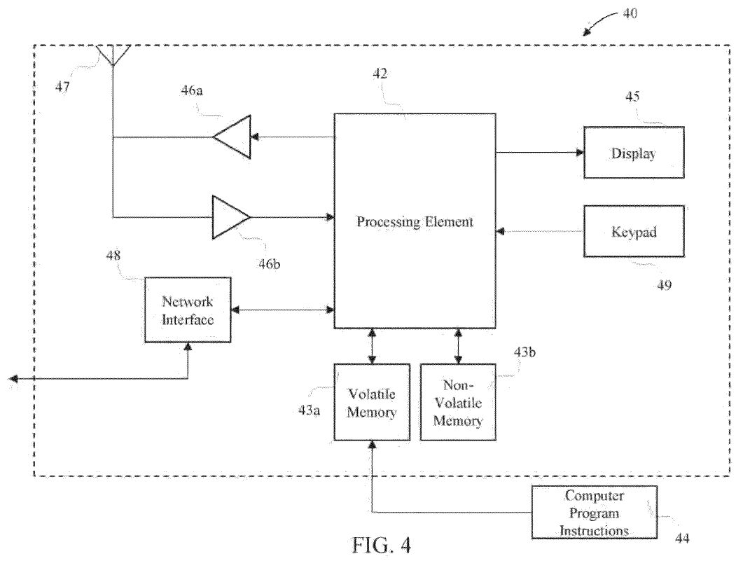

FIG. 4 provides an illustrative schematic representative of an external computing device 40 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. The external computing device 40 can be operated by various parties. As shown in FIG. 4, the external computing device 40 can include an antenna 47, a transmitter 46a (e.g., radio), a receiver 46b (e.g., radio), and a processing element 42 (e.g., CPLDs, microprocessors, multi-core processors, coprocessing entities, ASIPs, microcontrollers, and/or controllers) that provides signals to and receives signals from the transmitter 46a and receiver 46b, correspondingly.

The signals provided to and received from the transmitter 46a and the receiver 46b, correspondingly, may include signaling information/data in accordance with air interface standards of applicable wireless systems. In this regard, the external computing device 40 may be capable of operating with one or more air interface standards, communication protocols, modulation types, and access types. More particularly, the external computing device 40 may operate in accordance with any of a number of wireless communication standards and protocols, such as those described above with regard to the computing device 30. In a particular embodiment, the external computing device 40 may operate in accordance with multiple wireless communication standards and protocols, such as UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the external computing device 400 may operate in accordance with multiple wired communication standards and protocols, such as those described above with regard to the computing device 30 via a network interface 48.

Via these communication standards and protocols, the external computing device 40 can communicate with various other entities using concepts, such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing device 40 can also download changes, add-ons, and updates, for instance, to its firmware, software (e.g., including executable instructions, applications, program modules), and operating system.

According to one embodiment, the external computing device 40 may include location determining aspects, devices, modules, functionalities, and/or similar words used herein interchangeably. For example, the external computing device 40 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating a position of the external computing device 40 in connection with a variety of other systems, including cellular towers, Wi-Fi access points, and/or the like. Similarly, the external computing device 40 may include indoor positioning aspects, such as a location module adapted to acquire, for example, latitude, longitude, altitude, geocode, course, direction, heading, speed, time, date, and/or various other information/data. Some of the indoor systems may use various position or location technologies, including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The external computing device 40 may also comprise a user interface (that can include a display 45 coupled to the processing element 42) and/or a user input interface (coupled to the processing element 42). For example, the user interface may be a user application, browser, user interface, and/or similar words used herein interchangeably executing on and/or accessible via the external computing device 40 to interact with and/or cause display of information/data from the computing device 30, as described herein. The user input interface can comprise any of a number of devices or interfaces allowing the external computing device 40 to receive data, such as a keypad 49 (hard or soft), a touch display, voice/speech or motion interfaces, or other input device. In embodiments including a keypad 49, the keypad 49 can include (or cause display of) the conventional numeric (0-9) and related keys (#, *), and other keys used for operating the external computing device 40 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The external computing device 40 can also include volatile storage or memory 43a and/or non-volatile storage or memory 43b, which can be embedded and/or may be removable. For example, the non-volatile memory may be ROM, PROM. EPROM, EEPROM, flash memory, MMCs, SD memory cards, Memory Sticks, CBRAM, PRAM. FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory (43a, 43b) can store databases, database instances, database management systems, data, applications, programs, program modules, scripts, source code, object code, byte code, compiled code, interpreted code, machine code, executable instructions, and/or the like to implement the functions of the external computing device 40. As indicated, this may include a user application that is resident on the entity or accessible through a browser or other user interface for communicating with the computing device 30 and/or various other computing entities.

In another embodiment, the external computing device 40 may include one or more components or functionalities that are the same or similar to those of the computing device 30, as described in greater detail above. As will be recognized, these architectures and descriptions are provided for exemplary or illustrative purposes only and are not meant to limit the scope of this disclosure to one, some, or all of the various embodiments described herein.

In some embodiments, the apparatus 20 can comprise the computing device 30, the computing device 30 being suitable to carry out movement of the various components of the apparatus 20, flow rates or deposition/dispersal volumes, or the like. In some embodiments, the apparatus 20 or a component thereof, e.g., the computing device 30, can be configured to be in communication with the external computing device 40, which can be configured to provide instructions for printing, a design file for a printed article, printing nozzle and/or non-solvent vapor dispersion apparatus path instructions, or the like to the computing device 30, which is configured to carry out printing.

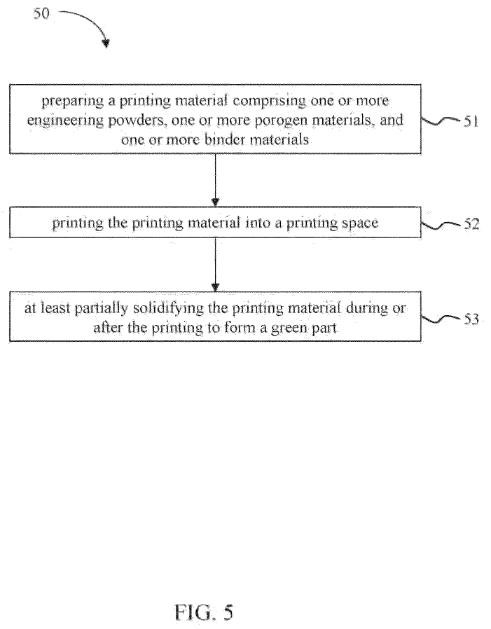

Referring now to FIG. 5, a method 50 for 3D printing of a metal article can comprise preparing a printing material comprising one or more engineering powders, one or more porogen materials, and one or more binder materials, at 51. In some embodiments, the method 50 can further comprise printing the printing material into a printing space, at 52.

In some embodiments, the printing 52 can comprise disposing the build material into the print space. By way of example only, the build material can be injected, spun, inserted, communicated, dropped, conveyed, or otherwise dispensed within the printing environment such that the non-solvent vapor can facilitate at least partial coagulation of the ink and formation of the green part. Regardless of the particular manner in which the build material is dispensed within the printing environment, the non-solvent vapor can cause sufficient coagulation of the printed ink by replacing the solvent in the ink and causing the deposited, at least partially coagulated build material (resulting from the solvent-exchanged ink) to be self-supporting, e.g., of layer-by-layer deposition. According to some embodiments, the intermediate article or finished article may be formed, according to the described approaches, free of printed support structures. Such support structures are used extensively across the array of conventional additive manufacturing and 3D printing techniques and are often required to be trimmed away after formation of the intermediate or finished article. By forming the intermediate article without printed supports, the methods described herein (e.g., the method 50) can eliminate the labor-intensive, costly, and time-consuming process step of trimming away the printed support structures once the article is fully formed.

In some embodiments, the one or more metal or ceramic powders can comprise at least one from among: iron, nickel, copper, silver, chromium, tin, titanium, cobalt, tungsten, vanadium, scandium, palladium, platinum, aluminum, gold, molybdenum, manganese, tantalum, beryllium, bismuth, hafnium, iridium, lanthanum, magnesium, niobium, osmium, silicon, yttrium, zinc, zirconium, alloys, other metals and their alloys thereof, or combinations thereof.

In some embodiments, the one or more solvents can comprise at least one from among: dimethyl sulfoxide, dimethylformamide (DMF), acetonitrile, ethanol, acetone, acrylic acid, benzene, benzyl alcohol, carbon tetrachloride, chloroform, cyclohexanol, dioxane, dimethylacetamide, ethyl acetate, ethyleneglycolmonobutylether, ethyleneglycolmonomethylether, formamide, methanol, methyl acetate, methylene dichloride, methyl-pyrrolidone, propanol, tetrahydrofuran, toluene, trichloroethylene, other applicable solvents or solvent mixtures, or combinations thereof. In some embodiments, the one or more solvents can comprise at least one from among: dimethyl sulfoxide (DMSO), dimethylformamide (DMF), acetonitrile, ethanol, variants thereof, combinations thereof, or the like.

In some embodiments, the one or more binder materials can comprise at least one from among: a wax, a polymer, a gel, a semi-solid, or a metal. In some embodiments, the one or more binder materials can comprise at least one from among: thermoplastic polymers, acrylonitrile-butadiene-styrene, polyurethane, acrylic, poly(acrylonitrile), polyolefins, polyvinyl chlorides, nylons, fluorocarbons, polystyrenes, polyethylene, ultra-high molecular weight polyethylene, polypropylene, polybutene, polymethylpentene, polyisoprene, polyethylene, ultra-high molecular weight polyethylene, polypropylene, ethylene-butene copolymers, ethylene-hexene copolymers, thermosetting plastics, polyimide (PI), poly amide (PA), poly amide imide (PAI), polypropylene (PP), polyethylene (PE), ethylene vinylacetate (EVA), poly(ethylene terephthalate) (PET), poly(vinyl acetate) (PVA), poly lactic-co-gly colic acid (PLGA), polylactic acid (PLA), polyamide (PA), acrylic adhesives, ultraviolet (UV)/electron beam (EB)/infrared (IR) curable resin, polyether ether ketone (PEEK), polyethylene naphthalate (PEN), polyethersulfone (PES), polyphenylene sulfide (PPS), polyphenylene oxide (PPO), copolymers thereof, variants thereof, or combinations thereof. In some embodiments, the one or more polymeric materials can comprise at least one from among: thermoplastic polymers, thermosetting polymers, acrylonitrile-butadiene-styrene, polyurethane, acrylic, poly(acrylonitrile), polyolefins, polyvinyl chlorides, nylons, fluorocarbons, polystyrenes, polyethylene, ultra-high molecular weight polyethylene, polypropylene, polybutene, polymethylpentene, polyisoprene, polyethylene, ultra-high molecular weight polyethylene, polypropylene, ethylene-butene copolymers, ethylene-hexene copolymers, thermosetting plastics, polyimide (PI), poly amide (PA), poly amide imide (PAI), polypropylene (PP), polyethylene (PE), ethylene vinylacetate (EVA), poly(ethylene terephthalate) (PET), poly-vinyl acetate (PVA), polyamide (PA), acrylic adhesives, ultraviolet (UV)/electron beam (EB)/infrared (IR) curable resin, polyether ether ketone (PEEK), polyethylene naphthalate (PEN), polyethersulfone (PES), polyphenylene sulfide (PPS), polyphenylene oxide (PPO), copolymers thereof, variants thereof, or any combination thereof. In some embodiments, the solvent for dissolution of the polymeric material(s) can be or comprise any suitable solvent, such as a solvent or solvent mixture comprising one or more of: dimethylsulfoxide (DMSO), ethanol. N-methylpyrrolidone, cyclodextrin, a pluronic detergent, liposomes, acetonitrile, N,N-Dimethylformamide (DMF), sodium methylsulfinylmethylide, dimethylsulfide, dimethyl sulfone, acetone, dimethylformamide, dimethylacetamide, N-methyl-2-pyrrolidone, HMPA, methanol, isopropanol, tert-butanol, acetic acid, ether, tetrahydrofuran, dichloromethane, chloroform, triethylamine, pyridine, ethyl acetate, variants thereof, combinations thereof, or the like.

In some embodiments, the one or more non-solvents may comprise one or more of: water, deionized water, water vapor, steam, water droplets, water having a miscible solvent dissolved therein, a non-solvent having a mutual miscibility with the chosen one or more solvents that satisfies a predetermined miscibility threshold, variants thereof, or combinations thereof.

In some embodiments, the method 50 can further comprise at least partially solidifying the printing material during the printing to form a green part, at 53.

In some embodiments, some or all of the method 50 can be carried out using a system such as described hereinabove. In some embodiments, some or all of the method 50 can be carried out using an apparatus such as the apparatus 20. In some embodiments, some or all of the method 50 can be carried out by an apparatus comprising one or more reservoirs configured to contain a supply of the liquid build material, a nozzle, and a computing device. In some embodiments, the nozzle is configured and dimensioned to move along a predetermined path within the volume of air to dispose a volume of the liquid build material. In some embodiments, the predetermined path is determined by the computing device based upon an input design file comprising a design of the finished article. In some embodiments, the apparatus can be configured to communicate the liquid build material from the reservoir, through the nozzle, and into the volume of air. In some embodiments, some aspects of the process or functionality of the apparatus can be at least partially controlled by a computing device (e.g., 30 or 40), and/or the like.

Referring now to FIG. 6, a method 60 for three-dimensional printing of a multi-material part can, optionally, comprise adjusting a ratio of the one or more porogen materials to the one or more engineering powders and the one or more binder materials prior to printing the printing material into the printing space to spatially tune the porosity and/or pore size of the sintered part, at 68. In some embodiments, the method 60 can comprise preparing a printing material comprising one or more engineering powders, one or more porogen materials, and one or more binder materials, at 61. In some embodiments, the method 60 can further comprise printing the printing material into a printing space, at 62. In some embodiments, the method 60 can further comprise at least partially solidifying the printing material during the printing to form a green part, at 63. In some embodiments, the method 60 can, optionally, further comprise partially solidifying the printing material during the printing to form the green part by delivering a non-solvent vapor to the printing material during printing to cause a vapor-induced phase separation of the one or more binder materials, at 64. In some embodiments, the method 60 can, optionally, further comprise removing the one or more porogen materials, at 65. In some embodiments, the method 60 can, optionally, further comprise sintering the green part to form a sintered part, by increasing a temperature of the green part from the temperature of the green part once formed to a temperature lower or greater than the melting point of one of the included components, at 66. In some embodiments, the method 60 can, optionally, further comprise at least partially coating the sintered part with a ceramic coating to form a finished part, at 67.

In some embodiments, once the green part is sintered, the sintered part can be coated with a ceramic coating. The ceramic coating can improve the biocompatibility of the part, such as for bone tissue engineering applications. In some embodiments, microbes can be used for microbially induced mineralization, which can comprise the formation of mineral(s) on one or more surfaces of the sintered part. In some embodiments, the ceramic coating can be formed by biomineralization of calcium carbonates or other mineral coatings using bacteria, such as prokaryotic bacterial, ureolytic bacteria, cyanobacteria, photosynthetic bacterial, sulfate reducing bacterial, urea hydrolyzing bacteria, bacteria that ammonify amino acids, bacteria that reduce nitrates, bacteria that form calcium carbonates from organic acids, combinations thereof, and/or the like. In some embodiments, the biomineralization process can be carried out by or with enzymes, proteins, microbes, bacteria, other microorganisms, combinations thereof, and/or the like. In some embodiments, the biomineralization process can form micro- and/or nano-structures on the outer surface of the porous sintered part. In some embodiments, such micro-and/or nano-structures on the outer surface of the porous sintered part can increase the surface area for bone tissue formation on the porous sintered part. In some embodiments, calcium derivatives, such as calcium phosphate and calcium carbonate, can be formed on surface(s) of the sintered part by microbially-induced calcium derivative precipitation.

In some embodiments, the ceramic coating can be caused to cover all or some of the sintered part by microbially-induced mineralization, microbially-induced calcium precipitation, microbially controlled calcium precipitation, or other suitable microbe-assisted bioceramic processes. Examples of some of the microbes and approaches that can be used for such microbially-induced mineralization are described in further detail by M.R. Fishman, et al. in “Physiological and genetic characterization of calcium phosphate precipitation by Pseudomonas species,” Sci Rep 8, 10156 (2018); J. Cosmidis et al, in “Calcium-phosphate biomineralization induced by alkaline phosphatase activity in Escherichia coli: localization, kinetics, and potential signatures in the fossil record,” Front. Earth Sci.; and Y. Lei, et al, in “Energy efficient phosphorus recovery by microbial electrolysis cell induced calcium phosphate precipitation,” ACS Sustainable Chemistry & Engineering 2019 7 (9), 8860-8867, the entire disclosure of each of which are incorporated herein by reference in their entireties for all purposes.

In some embodiments, some or all of the method 60 can be carried out using a system such as described hereinabove. In some embodiments, some or all of the method 60 can be carried out using an apparatus such as the apparatus 20. In some embodiments, some or all of the method 60 can be carried out by an apparatus comprising one or more reservoirs configured to contain a supply of the liquid build material, a nozzle, and a computing device. In some embodiments, the nozzle is configured and dimensioned to move along a predetermined path within the volume of air to dispose a volume of the liquid build material. In some embodiments, the predetermined path is determined by the computing device based upon an input design file comprising a design of the finished article. In some embodiments, the apparatus can be configured to communicate the liquid build material from the reservoir, through the nozzle, and into the volume of air. In some embodiments, some aspects of the process or functionality of the apparatus can be at least partially controlled by a computing device (e.g., 30 or 40), and/or the like.

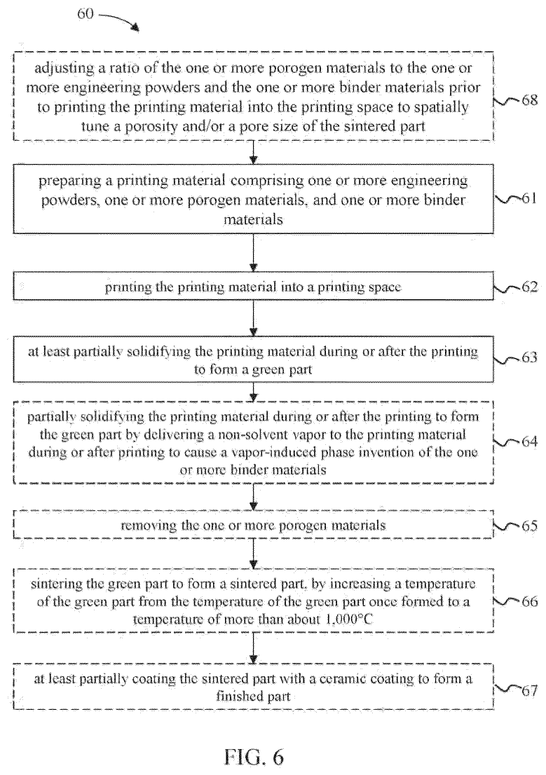

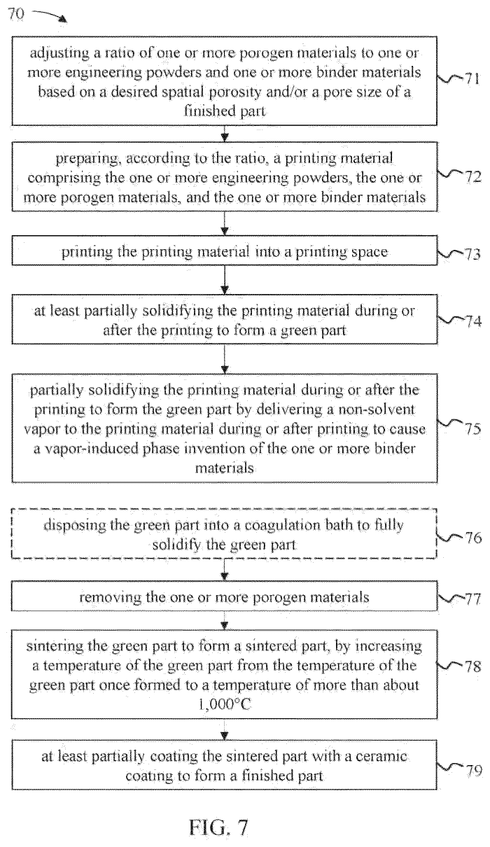

Referring now to FIG. 7, a method 70 for three-dimensional printing of a multi-material part can comprise adjusting a ratio of one or more porogen materials to one or more engineering powders and one or more binder materials based on a desired spatial porosity and/or a pore size of a finished part, at 71. In some embodiments, the method 70 can further comprise preparing, according to the ratio, a printing material comprising the one or more engineering powders, the one or more porogen materials, and the one or more binder materials, at 72. In some embodiments, the method 70 can further comprise printing the printing material into a printing space, at 73. In some embodiments, the method 70 can further comprise at least partially solidifying the printing material during the printing to form a green part, at 74. In some embodiments, the method 70 can further comprise partially solidifying the printing material during the printing to form the green part by delivering a non-solvent vapor to the printing material during printing to cause a vapor-induced phase separation of the one or more binder materials, at 75. In some embodiments, the method 70 can, optionally, further comprise disposing the green part into a coagulation bath to fully solidify the green part, at 76. In some embodiments, the method 70 can further comprise removing the one or more porogen materials, at 77. In some embodiments, the method 70 can further comprise sintering the green part to form a sintered part, by increasing a temperature of the green part from the temperature of the green part once formed to a temperature lower or greater than the melting point of one of the included components, at 78. In some embodiments, the method 70 can further comprise at least partially coating the sintered part with a ceramic coating to form a finished part, at 79.

In some embodiments, some or all of the method 70 can be carried out using a system such as described hereinabove. In some embodiments, some or all of the method 70 can be carried out using an apparatus such as the apparatus 20. In some embodiments, some or all of the method 70 can be carried out by an apparatus comprising one or more reservoirs configured to contain a supply of the liquid build material, a nozzle, and a computing device. In some embodiments, the nozzle is configured and dimensioned to move along a predetermined path within the volume of air to dispose a volume of the liquid build material. In some embodiments, the predetermined path is determined by the computing device based upon an input design file comprising a design of the finished article. In some embodiments, the apparatus can be configured to communicate the liquid build material from the reservoir, through the nozzle, and into the volume of air. In some embodiments, some aspects of the process or functionality of the apparatus can be at least partially controlled by a computing device (e.g., 30 or 40), and/or the like.

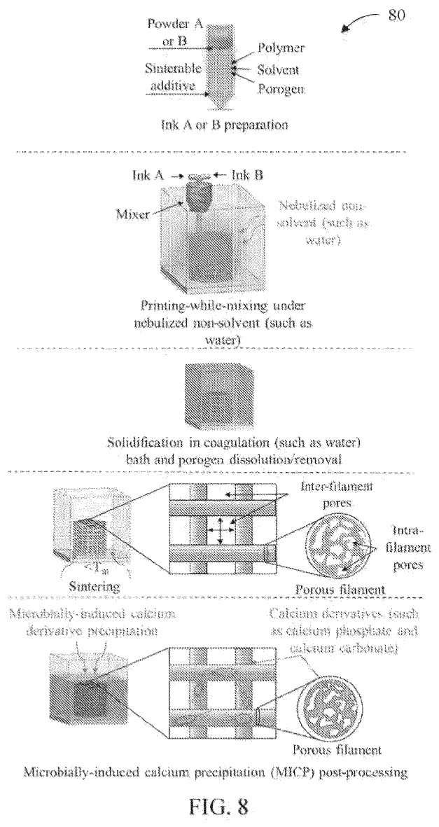

Referring now to FIG. 8, a process 80 is provided for fabricating multi-material parts with multi-scale tunable porosity/pore size and enhanced biocompatibility. According to an embodiment, the fabrication process 80 can comprise:
The suspension ink for printing is prepared by mixing the base powders (such as metallic and/or ceramic powders) with a binder (dissolved polymer using the proper solvent(s)), and a pore-forming porogen material, if intra-filament porosity is desired. It must be noted that it is required for the porogen not to be soluble in the solvent, so it can be deposited along with the binder and the selected powders.
Subsequently, the ink is extrusion-printed into a 3D part in air in an enclosed chamber at room temperature while a non-solvent vapor is delivered to the part being printed for partial solidification. Since the build material ink is prepared as a suspension, various powders can be easily mixed at different ratios in situ and controllably deposited for parts with a functional gradient as designed by the use of a mixer. This opens up possibilities for printing various multi-material composites. The non-solvent extracts the solvent away due to its higher Hansen chemical affinity with the solvent and then partially solidifies the part based on the phase inversion mechanism of the polymeric constituent. At this stage, the inter-filament porosity can be adjusted by the printing path of deposited filaments.
In addition, the inter-filament spacing can be adjusted as desired by the selection of the printing path, which enables the customization of porosity at the macro-scale level. Such spacing can be easily changed in a layer-to-layer fashion to spatially accommodate any required process and part-related flexibility.
Subsequently, the printed part is further processed in a coagulation bath for complete solidification of the part and removal of the porogen material from the deposited filaments. At this stage, the volume once occupied by the porogen material becomes a void space at the intra-filament level. The solidified polymer acts as a binding agent for the powder particles filled with pores.
Subsequently, the printed green part undergoes a thermal cycle that aims at removing the sacrificial binder (debinding stage) and sintering the selected powders (usually at temperatures of 70-90% of the melting point). In this case, only the powder-filled regions are densified, leaving the inter-filament and intra-filament pores intact.
Subsequently, the part undergoes a microbially-induced calcium precipitation (MICP) post-processing step to have a micro-and nano-scale calcium phosphate (using bacteria such as Pseudomonas species) or calcium carbonate (using a urease-producing haloalkalophilic bacterial strain such as Sporosarcina pasteurii) coating for increased biocompatibility and osseointegration performance.

### Select Experimental Results

According to one experimental example,

To illustrate the feasibility of the proposed printing technology, porous austenitic stainless steel 316L-based parts and 316L-hydroxyapatite (HAp) composites are printed. The starting inks are obtained by mixing a solution prepared from a polymer binder (acrylonitrile-butadiene-styrene (ABS)) and a non-volatile solvent (dimethyl sulfoxide (DMSO)) with build material powders (stainless steel 316L) and porogen particles (sodium chloride (NaCl)). For the composite parts, HAp powders are also mixed. The feasibility of the proposed porous multi-material printing technology is studied by extrusion printing some scaffold-based structures, that present the inter-filament porosity based on the spacing between deposited filaments.

The detailed fabrication method follows the process flow shown in FIG. 1. First, 316L powder (MSE Supplies, Tucson, AZ, USA) is mixed with a solution of DMSO (Bioreagent grade, Fisher Scientific, Fair Lawn, NJ, USA) with 25% (w/v) ABS (ABSplus P430, Stratasys, Eden Prairie, MI, USA). For the porous structure fabrication, sodium chloride powders (NaCl, GDF Chemicals, Powell, OH, USA) treated by an 80-mesh filter are added. Alternatively, HAp powder (Sigma, St. Louis, MI, USA) can be added at a certain ratio (herein, 5 wt. %) for 316L-HAp composite printing. The polymeric mixture is continuously stirred for homogeneous mixing using a roller mixer (DLAB Scientific. Riverside, CA, USA) and a centrifugal mixer (AR-100, Thinky, CA, USA) is used upon powder loading for 1 minute, and then loaded in a disposable 5 mL syringe fitted with a stainless steel 18-gauge tip (Nordson EFD, Vilters, Switzerland). The syringe is assembled onto a Hyrel Engine SR 3D printer (Hyrel3D, Norcross, GA, USA). Some parameters used are: a layer thickness of 0.2-0.4 mm and a path speed of 2-4 mm/s. This setup can easily be extended to print multi-materials with variable composition by the use of a mixer while different inks are simultaneously being fed. Deionized water mist is supplied simultaneously using a nebulizer (Lumiscope, East Rutherford, NJ, USA) as a non-solvent while printing in order to induce partial solidification onto the structure being printed based on the vapor-induced phase inversion mechanism. The 3D printed part is then immersed in 100 mL of a water-based coagulation bath for 1 hour to enhance the replacement of the solvent (DMSO) with non-solvent (water) and therefore fully solidify the printed green part. In this step, the porogen particles embedded within the intra-filament region are dissolved in the water bath, obtaining a porous green part. Then, a sintering cycle is applied (1300° C., 2h) to the solidified green part to burn out the ABS and further sinter the 316L and/or HAp powders. The thermal cycle applied to the 3D green part is carried under vacuum conditions and a controlled exhaust system.

As a demonstration of metal-ceramic composite scaffold printing, a 316L-HAp structure with a weight ratio of 95 wt. % to 5 wt. % was printed. The introduction of HAp did not interfere with the stainless-steel sintering process, and further energy-dispersive X-ray spectroscopy confirmed the presence of calcium and phosphorus in small amounts.

It is contemplated that the approaches, methods, processes, apparatuses, computer program products, computer-readable media, devices, and systems described herein can be applied for a variety of implementations, which may result in: print structures with spatially tunable porosity and pore size; print multi-material structures from different materials including metals, ceramics, polymers, composites, and/or biomaterials; print porous structures with tunable inter-filament and intra-filament porosities, and/or tunable mechanical properties; and/or print structures with increased intra-filament porosity, which may yield on a higher surface area for calcium derivative precipitation, resulting in highly bioactive parts.

### Example Printed Articles

One or more of the described processes, e.g., 10 or 80, (including parts or variations thereof) can be carried out for the fabrication of arbitrary parts in arbitrary orientations. In other words, the complexity, costliness, and time necessary to carry out fabrication is at least partially decoupled from the shape, dimensions, and complexity of the article being fabricated. The implications for practical applications are surprising and significant. Conversely, 3D printing a metal article, e.g., an article having high complexity, according to conventional processes requires a significant amount of thought, time, and/or computing power be dedicated to the printing orientation of the part to maximize printing precision and minimize printing time, requires careful placement of printed support structures such that the printed article is sufficiently stabilized and such that the printed support structures are minimized, and requires time, labor, and therefore cost to trim away the support structures from the finished article, a process which sometimes damages the printed article such that the printed article must be scrapped. The 3D printing methods, e.g., the methods 50, 60, 70, described herein can eliminate the need for a particular orientation, are not rendered more time-consuming or costly with increasing article complexity, and do not require support structures to be printed concurrent to the printing of the article, meaning less 3D printing/build material is wasted and the printed support structure trimming step is eliminated completely. The advantages in terms of production cost and time for 3D printed articles, among other advantages associated with these methods, are clear.

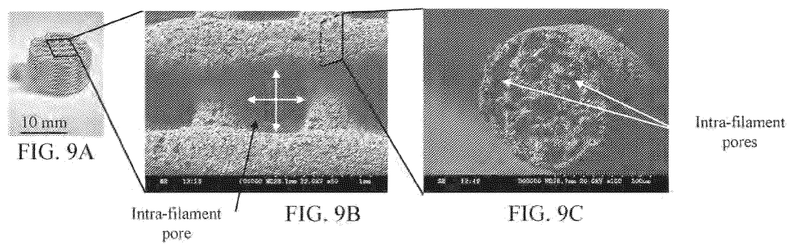

By way of example only, some examples of 3D printed metal articles printed according to the process 80 and using the build material described above are illustrated in FIGS. 9A-9C, 10A-10C, and 11A-11B. Powder suspensions for 3D printing an example article were obtained by mixing ABS, DMSO, stainless steel 316L, and NaCl as the porogen material, e.g., according to the process 80 described above. After a printed structure was fully solidified, the porosity ranged from about 40% to about 60%, as shown in FIG. 9A. Scanning electron microscopy (SEM) images confirmed the presence of open pores as observed on the outermost surface of the filament, as shown in FIG. 9B, with inter-filament pores having a pore size of about 700 μm. The intra-filament pores were also observed in the filament's cross-section, as shown in FIG. 9C. The pore size was found to be about 150 μm, which matches the porogen particle size used in this experimental example, and was found to be easily extendable to other desired pore sizes by adjusting the initial porogen particle size. The presence of pores notably reduces the mechanical properties of the final part; specifically, the elasticity modulus is measured to be between about 0.7 GPa and about 2.0 GPa, and the ultimate tensile strength (UTS) was between about 70 GPa and about 120 GPa, down between about 65% and about 45% for representative intra-filament porosity values.

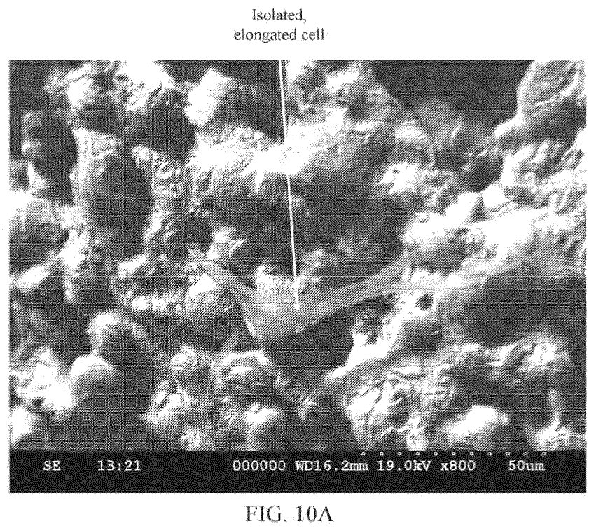

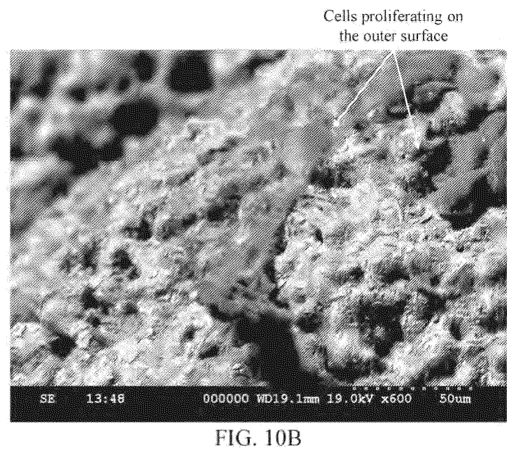

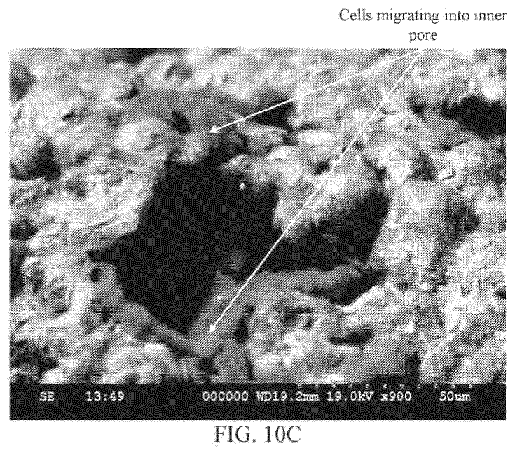

The cell seeding and proliferation behavior on the stainless steel 316L porous scaffolds was carried out using NIH 3T3 fibroblast cells, as they are a physiologically-relevant cell type in bone tissue engineering due to their relevant adhesion behavior. Cell morphologies were evaluated after culturing for 1, 3, and 7 days. The SEM images suggest that the porous nature of the scaffold allows cell growth and migration in such pores while being alive. In particular, on Day 1 isolated, elongated cells are observed as extending and spanning over the porous outer surface, as illustrated in FIG. 10A. Significant cell proliferation is observed on the outer surface on Day 3, as illustrated in FIG. 10B, followed by fibroblast cells populating into the pores after 7 days of culturing, as illustrated in FIG. 10C.

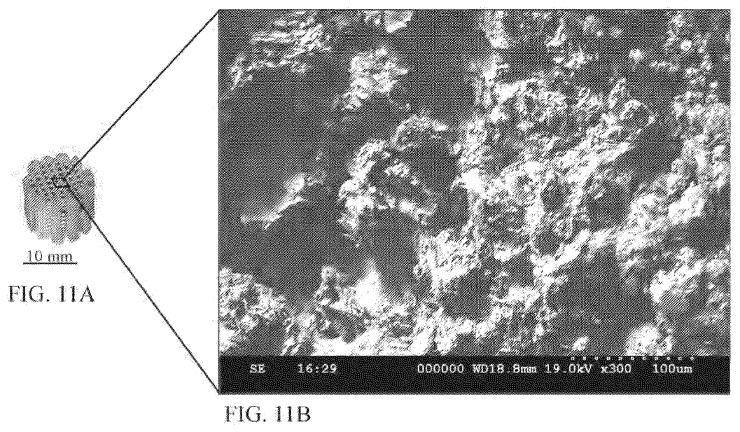

As a demonstration of metal-ceramic composite scaffold printing, a 316L-HAp structure with a weight ratio of about 95 wt. % 316L to about 5 wt. % HAp was printed, as illustrated in FIG. 11A. The introduction of HAp did not interfere with the stainless-steel sintering process, as observed in FIG. 11B, and further energy-dispersive X-ray spectroscopy confirmed the presence of calcium and phosphorus in small amounts.

As noted herein, there are many advantages to using the disclosed green part printing and sintering process, especially when compared with conventional 3D printing processes for bone tissue engineering applications. The described processes and methods may be applied to, among other things: (i) print metal/ceramic-containing scaffold structures from a metal/ceramic powder suspension starting from a wide range of particle sizes, using a wide array of print material chemical compositions, and/or accommodating a large range of possible porosities by adjusting characteristics of the porogen material used, for example; (ii) print homogeneous and heterogeneous metallic/ceramic parts in air; (iii) print meta-material structures; (iv) print multi-material structures from different materials including metals, ceramics, polymers, composites, and/or biomaterials; and (v) print porous metal structures for applications where mass flow through a part is required (e.g., filters, heat exchangers, biomedical implants, etc.).

### Conclusions

Described generally herein, according to at least some embodiments, are apparatuses, systems, and methods for three-dimensional (3D) printing of engineered parts with spatially tunable porosity. A printing material can include engineering powder(s) (e.g., metals or ceramics), binder(s), sinterable additive(s), polymer(s), porogen(s), and/or solvent(s). After printing, vapor-based phase inversion of the printing material causes at least partial solidification to form a green part. The part can be immersed in a coagulation bath for complete solidification, if needed. Debinding of the part can remove some or all of the polymer(s). The porogen material(s) can be removed to form a porous, sinterable part. The part is then sintered to control grain size and improve mechanical properties of the part. A biocompatible ceramic coating can be applied to the part to increase biocompatibility. The ratio of porogen to other components of the printing material can be adjusted (i.e., tuned) to achieve a desired porosity and pore size in the finished part.

According to one embodiment, a method can be carried out that comprises: preparing a printing material comprising one or more engineering powders, one or more porogen materials, and one or more binder materials; printing the printing material into a printing space; and at least partially solidifying the printing material during the printing to form a green part. In some embodiments, the method can further comprise: partially solidifying the printing material during the printing to form the green part by delivering a non-solvent vapor to the printing material during printing to cause a vapor-induced phase separation of the one or more binder materials. In some embodiments, the method can further comprise: removing the one or more porogen materials. In some embodiments, the method can further comprise: sintering the green part to form a sintered part, by increasing a temperature of the green part from the temperature of the green part once formed to a temperature lower or greater than the melting point of one of the included components. In some embodiments, the method can further comprise: adjusting a ratio of the one or more porogen materials to the one or more engineering powders and the one or more binder materials prior to printing the printing material into the printing space to spatially tune the porosity and/or pore size of the sintered part. In some embodiments, the method can further comprise: at least partially coating the sintered part with a ceramic coating to form a finished part.

In some embodiments, the one or more engineering powders can comprise one or more of: a ceramic, carbon, silica, clay, sand, silt, mud, loam, a metal, kaolinite, montmorillonite, hydrous aluminum phyllosilicates, illite, vermiculite, magnesium silicates, aluminum silicate hydroxide, porcelain, lime, iron oxide, magnesia, alumina, nitrides, carbides, beryllias, cerias, zirconias, borides, silicides, or combinations thereof.

In some embodiments, the one or more engineering powders can comprise a metal selected from among: stainless steel, carbon, iron, cobalt, chromium, titanium, gold, calcium, phosphorous, gallium, lithium, magnesium, manganese, silver, strontium, vanadium, aluminum, tantalum, nickel, nitrogen, copper, zinc, zirconium, hafnium, niobium, yttrium, thoria, molybdenum, oxides thereof, alloys thereof, or any combination thereof.

In some embodiments, the one or more porogen materials can comprise one or more of: a salt, a sugar, a wax, a gel, a protein, a peptide, a biomaterial, a sol-gel, a rubber, alginate, a polymer, high internal phase emulsions, polycaprolactone, calcium phosphate, thermoplastic polymers, crystals thereof, beads thereof, or combinations thereof.

In some embodiments, the one or more binder materials can comprise a polymer.

In some embodiments, the printing of the printing material into the printing space can comprise printing by layer-by-layer stacking, powder bed fusion, direction deposition technology, extrusion, injection molding, or a combination thereof.

In some embodiments, the sintering of the green part can comprise one or more of: selective layer sintering, selective laser melting, electron beam melting, direct metal laser sintering, capacitor discharge sintering, continuous mesh belt furnace sintering, electro sinter forging, pressure-less sintering, microwave sintering, spark plasma sintering, electric current assisted sintering, transient liquid phase sintering, permanent liquid phase sintering, liquid phase sintering, metallic powder sintering, hot isostatic pressing, direct current in vacuum sintering, sinter hardening, tempering, or fritting.

According to another embodiment, an apparatus can be provided that comprises: a processor; a memory storing computer program code, wherein the memory and the computer program code are configured, with the processor, to cause the apparatus to carry out at least the following: preparing a printing material comprising one or more engineering powders, one or more porogen materials, and one or more binder materials; printing the printing material into a printing space; and at least partially solidifying the printing material during the printing to form a green part.

In some embodiments, the memory and the computer program code are further configured, with the processor, to cause the apparatus to carry out at least the following: partially solidifying the printing material during the printing to form the green part by delivering a non-solvent vapor to the printing material during printing to cause a vapor-induced phase separation of the one or more binder materials.

In some embodiments, the memory and the computer program code are further configured, with the processor, to cause the apparatus to carry out at least the following: removing the one or more porogen materials.

In some embodiments, the memory and the computer program code are further configured, with the processor, to cause the apparatus to carry out at least the following: sintering the green part to form a sintered part, by increasing a temperature of the green part from the temperature of the green part once formed to a temperature lower or greater than the melting point of one of the included components.

In some embodiments, the memory and the computer program code are further configured, with the processor, to cause the apparatus to carry out at least the following: adjusting a ratio of the one or more porogen materials to the one or more engineering powders and the one or more binder materials prior to printing the printing material into the printing space to spatially tune the porosity and/or pore size of the sintered part.

In some embodiments, the memory and the computer program code are further configured, with the processor, to cause the apparatus to carry out at least the following: at least partially coating the sintered part with a ceramic coating to form a finished part.

In some embodiments, the one or more engineering powders can comprise one or more of: a ceramic, carbon, silica, clay, sand, silt, mud, loam, a metal, kaolinite, montmorillonite, hydrous aluminum phyllosilicates, illite, vermiculite, magnesium silicates, aluminum silicate hydroxide, porcelain, lime, iron oxide, magnesia, alumina, nitrides, carbides, beryllias, cerias, zirconias, borides, silicides, or combinations thereof.

In some embodiments, the one or more engineering powders can comprise a metal selected from among: stainless steel, carbon, iron, cobalt, chromium, titanium, gold, calcium, phosphorous, gallium, lithium, magnesium, manganese, silver, strontium, vanadium, aluminum, tantalum, nickel, nitrogen, copper, zinc, zirconium, hafnium, niobium, yttrium, thoria, molybdenum, oxides thereof, alloys thereof, or any combination thereof.

In some embodiments, the one or more porogen materials can comprise one or more of: a salt, a sugar, a wax, a gel, a protein, a peptide, a biomaterial, a sol-gel, a rubber, alginate, a polymer, high internal phase emulsions, polycaprolactone, calcium phosphate, thermoplastic polymers, crystals thereof, beads thereof, or combinations thereof.

In some embodiments, the one or more binder materials can comprise a polymer.

In some embodiments, the printing of the printing material into the printing space can comprise printing by layer-by-layer stacking, powder bed fusion, direction deposition technology, extrusion, injection molding, or a combination thereof.

In some embodiments, the sintering of the green part can comprise one or more of: selective layer sintering, selective laser melting, electron beam melting, direct metal laser sintering, capacitor discharge sintering, continuous mesh belt furnace sintering, electro sinter forging, pressure-less sintering, microwave sintering, spark plasma sintering, electric current assisted sintering, transient liquid phase sintering, permanent liquid phase sintering, liquid phase sintering metallic powder sintering, hot isostatic pressing, direct current in vacuum sintering, sinter hardening, tempering, or fritting.

In some embodiments, once the green part is sintered, the sintered part can be coated with a ceramic coating. The ceramic coating can improve the biocompatibility of the part, such as for bone tissue engineering applications. In some embodiments, microbes can be used for microbially induced mineralization, which can comprise the formation of mineral(s) on one or more surfaces of the sintered part. In some embodiments, the ceramic coating can be formed by biomineralization of calcium carbonates or other mineral coatings using bacteria, such as prokaryotic bacterial, ureolytic bacteria, cyanobacteria, photosynthetic bacterial, sulfate reducing bacterial, urea hydrolyzing bacteria, bacteria that ammonify amino acids, bacteria that reduce nitrates, bacteria that form calcium carbonates from organic acids, combinations thereof, and/or the like. In some embodiments, the biomineralization process can be carried out by or with enzymes, proteins, microbes, bacteria, other microorganisms, combinations thereof, and/or the like. In some embodiments, the biomineralization process can form micro- and/or nano-structures on the outer surface of the porous sintered part. In some embodiments, such micro-and/or nano-structures on the outer surface of the porous sintered part can increase the surface area for bone tissue formation on the porous sintered part. In some embodiments, calcium derivatives, such as calcium phosphate and calcium carbonate, can be formed on surface(s) of the sintered part by microbially-induced calcium derivative precipitation.

According to another embodiment, a non-transitory computer-readable medium can be provided that stores instructions which, when executed by a processor, cause at least the following: preparing a printing material comprising one or more engineering powders, one or more porogen materials, and one or more binder materials; printing the printing material into a printing space; and at least partially solidifying the printing material during the printing to form a green part.

In some embodiments, the non-transitory computer-readable medium can further store instructions which, when executed by the processor, cause at least the following: partially solidifying the printing material during the printing to form the green part by delivering a non-solvent vapor to the printing material during printing to cause a vapor-induced phase separation of the one or more binder materials.

In some embodiments, the non-transitory computer-readable medium can further store instructions which, when executed by the processor, cause at least the following: removing the one or more porogen materials.

In some embodiments, the non-transitory computer-readable medium can further store instructions which, when executed by the processor, cause at least the following: sintering the green part to form a sintered part, by increasing a temperature of the green part from the temperature of the green part once formed to a temperature close to the melting point of one of the included components.

In some embodiments, the non-transitory computer-readable medium can further store instructions which, when executed by the processor, cause at least the following: adjusting a ratio of the one or more porogen materials to the one or more engineering powders and the one or more binder materials prior to printing the printing material into the printing space to spatially tune the porosity and/or pore size of the sintered part.

In some embodiments, the non-transitory computer-readable medium can further store instructions which, when executed by the processor, cause at least the following: at least partially coating the sintered part with a ceramic coating to form a finished part.

In some embodiments, the one or more engineering powders can comprise one or more of: a ceramic, carbon, silica, clay, sand, silt, mud, loam, a metal, kaolinite, montmorillonite, hydrous aluminum phyllosilicates, illite, vermiculite, magnesium silicates, aluminum silicate hydroxide, porcelain, lime, iron oxide, magnesia, alumina, nitrides, carbides, beryllias, cerias, zirconias, borides, silicides, or combinations thereof.

In some embodiments, the one or more engineering powders can comprise a metal selected from among: stainless steel, carbon, iron, cobalt, chromium, titanium, gold, calcium, phosphorous, gallium, lithium, magnesium, manganese, silver, strontium, vanadium, aluminum, tantalum, nickel, nitrogen, copper, zinc, zirconium, hafnium, niobium, yttrium, thoria, molybdenum, oxides thereof, alloys thereof, or any combination thereof.

In some embodiments, the one or more porogen materials can comprise one or more of: a salt, a sugar, a wax, a gel, a protein, a peptide, a biomaterial, a sol-gel, a rubber, alginate, a polymer, high internal phase emulsions, polycaprolactone, calcium phosphate, thermoplastic polymers, crystals thereof, beads thereof, or combinations thereof.

In some embodiments, the one or more binder materials can comprise a polymer.

In some embodiments, the printing of the printing material into the printing space can comprises printing by layer-by-layer stacking, powder bed fusion, direction deposition technology, extrusion, injection molding, or a combination thereof.

In some embodiments, the sintering of the green part can comprise one or more of: selective layer sintering, selective laser melting, electron beam melting, direct metal laser sintering, capacitor discharge sintering, continuous mesh belt furnace sintering, electro sinter forging, pressure-less sintering, microwave sintering, spark plasma sintering, electric current assisted sintering, transient liquid phase sintering, permanent liquid phase sintering, liquid phase sintering metallic powder sintering, hot isostatic pressing, direct current in vacuum sintering, sinter hardening, tempering, or fritting.

According to another embodiment, a system can be provided that comprises: a first reservoir storing a first printing material, the first printing material comprising first inorganic particles, a first sinterable material, a first binder material, and a first porogen material suspended in a first solvent; a second reservoir storing a second printing material, the second printing material comprising second inorganic particles, a second sinterable material, a second binder material, and a second porogen material suspended in a second solvent; a printing nozzle disposed within a printing space, the printing nozzle being in fluidic communication with the first reservoir and the second reservoir and configured to receive a volume of the first printing material and a volume of the second printing material, the printing nozzle being configured to dispose a mixture of the first and second printing materials into the printing space during a printing period; a vapor dispersion apparatus in fluidic communication with the printing space and configured to disperse a volume of a nonsolvent vapor into the printing space during the printing period to form a green part from the mixture of the first and second printing materials by at least partially solidifying the mixture of the first and second printing materials in the printing space; and a computing device configured to cause printing of the first and second printing materials into the printing space during the printing period, wherein causing printing comprises causing movement of the printing nozzle along a predetermined pathway through the printing space, causing the printing nozzle to dispose portions of the first and second printing materials into the printing space and along the predetermined pathway during the printing period, and causing the vapor dispersion apparatus to disperse the volume of the nonsolvent vapor into the printing space during the printing period.

In some embodiments, the system can further comprise: a coagulation bath configured to receive the green part after the at least partial solidification of the mixture of the first and second printing material, the coagulation bath configured to fully solidify the green part.

In some embodiments, the system can further comprise: a porogen leaching bath configured to receive the green part after the at least partial solidification of the mixture of the first and second printing material, the porogen leaching bath configured to remove substantially all of the first porogen material and the second porogen material from the green part.

In some embodiments, the system can further comprise: a sintering apparatus configured to sinter the green part at a temperature lower or greater than the melting point of one of the included components, forming a sintered part.

In some embodiments, the system can further comprise: a ceramic coating apparatus configured to dispose a ceramic material onto at least a portion of an outer surface of the sintered part.

In some embodiments, the one or more engineering powders can comprise one or more of: a ceramic, carbon, silica, clay, sand, silt, mud, loam, a metal, kaolinite, montmorillonite, hydrous aluminum phyllosilicates, illite, vermiculite, magnesium silicates, aluminum silicate hydroxide, porcelain, lime, iron oxide, magnesia, alumina, nitrides, carbides, beryllias, cerias, zirconias, borides, silicides, or combinations thereof.

In some embodiments, the one or more engineering powders can comprise a metal selected from among: stainless steel, carbon, iron, cobalt, chromium, titanium, gold, calcium, phosphorous, gallium, lithium, magnesium, manganese, silver, strontium, vanadium, aluminum, tantalum, nickel, nitrogen, copper, zinc, zirconium, hafnium, niobium, yttrium, thoria, molybdenum, oxides thereof, alloys thereof, or any combination thereof.

In some embodiments, the one or more porogen materials can comprise one or more of: a salt, a sugar, a wax, a gel, a protein, a peptide, a biomaterial, a sol-gel, a rubber, alginate, a polymer, high internal phase emulsions, polycaprolactone, calcium phosphate, thermoplastic polymers, crystals thereof, beads thereof, or combinations thereof.

In some embodiments, the one or more binder materials can comprise a polymer.

In some embodiments, the printing of the printing material into the printing space can comprises printing by layer-by-layer stacking, powder bed fusion, direction deposition technology, extrusion, injection molding, or a combination thereof.

In some embodiments, the sintering of the green part can comprise one or more of: selective layer sintering, selective laser melting, electron beam melting, direct metal laser sintering, capacitor discharge sintering, continuous mesh belt furnace sintering, electro sinter forging, pressure-less sintering, microwave sintering, spark plasma sintering, electric current assisted sintering, transient liquid phase sintering, permanent liquid phase sintering, liquid phase sintering metallic powder sintering, hot isostatic pressing, direct current in vacuum sintering, sinter hardening, tempering, or fritting.

It should be appreciated that all combinations of the foregoing concepts and additional concepts discussed in greater detail below (provided such concepts are not mutually inconsistent) are contemplated as being part of the inventive subject matter disclosed herein. In particular, the combinations of claimed subject matter appearing at the end of this disclosure are contemplated as being part of the inventive subject matter disclosed herein. It should be appreciated that terminology explicitly employed herein that also may appear in any disclosure incorporated by reference should be accorded a meaning consistent with the particular concepts disclosed herein.

In some embodiments, one or more of the operations, steps, elements, or processes described herein may be modified or further amplified as described below. Moreover, in some embodiments, additional optional operations may also be included. It should be appreciated that each of the modifications, optional additions, and/or amplifications described herein may be included with the operations previously described herein, either alone or in combination, with any others from among the features described herein.

The provided method description, illustrations, and process flow diagrams are provided merely as illustrative examples and are not intended to require or imply that the steps of the various embodiments must each or all be performed and/or should be performed in the order presented or described. As will be appreciated by one of skill in the art, the order of steps in some or all of the embodiments described may be performed in any order. Words such as “thereafter,” “then,” “next,” etc, are not intended to limit the order of the steps; these words are simply used to guide the reader through the description of the methods. Further, any reference to claim elements in the singular, for example, using the articles “a,” “an,” or “the” is not to be construed as limiting the element to the singular. Further, any reference to dispensing, disposing, depositing, dispersing, conveying, injecting, inserting, communicating, and other such terms of art are not to be construed as limiting the element to any particular means or method or apparatus or system, and is taken to mean conveying the material within the receiving vessel, solution, conduit, or the like by way of any suitable method.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components may be used in conjunction with the system. Therefore, it is to be understood that the inventions are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation. Specific equipment and materials described in the examples are for illustration only and not for purposes of limitation. For instance, any and all articles, portions of articles, structures, bulk materials, and/or the like, having any form factor, scale, dimensions, aesthetic attributes, material properties, internal structures, and/or mechanical properties, which are formed according to any of the disclosed methods, approaches, processes, or variations thereof, using any devices, equipment, apparatuses, systems, or variations thereof, using any of the build material, printing mixture, ink, yield-stress support material, or other material compositions described herein or variations thereof, are all contemplated and covered by the present disclosure. None of the examples provided are intended to, nor should they, limit in any way the scope of the present disclosure.

The various portions of the present disclosure, such as the Background, Summary, Brief Description of the Drawings, and Abstract sections, are provided to comply with requirements of the MPEP and are not to be considered an admission of prior art or a suggestion that any portion or part of the disclosure constitutes common general knowledge in any country in the world. The present disclosure is provided as a discussion of the inventor's own work and improvements based on the inventor's own work. See, e.g., Riverwood Int'l Corp, v. R.A. Jones & Co., 324 F.3d 1346, 1354 (Fed. Cir. 2003).

In some embodiments, one or more of the operations, steps, or processes described herein may be modified or further amplified as described below. Moreover, in some embodiments, additional optional operations may also be included. It should be appreciated that each of the modifications, optional additions, and/or amplifications described herein may be included with the operations previously described herein, either alone or in combination, with any others from among the features described herein.

Although specific advantages have been enumerated above, various embodiments may include some, none, or all of the enumerated advantages.

Other technical advantages may become readily apparent to one of ordinary skill in the art after review of the following figures and description.

It should be understood that, although exemplary embodiments are illustrated in the figures and described below, the principles of the present disclosure may be implemented using any number of techniques, whether currently known or not. The present disclosure should in no way be limited to the examples, experimental results, exemplary embodiments, preferred configurations, illustrated equipment, disclosed processes, or particular implementations and techniques illustrated in the drawings and described below.

The provided method description, illustrations, and process flow diagrams are provided merely as illustrative examples and are not intended to require or imply that the steps of the various embodiments must each or all be performed and/or should be performed in the order presented or described. As will be appreciated by one of skill in the art, the order of steps in some or all of the embodiments described may be performed in any order. Words such as “thereafter,” “then,” “next,” etc, are not intended to limit the order of the steps; these words are simply used to guide the reader through the description of the methods. Further, any reference to claim elements in the singular, for example, using the articles “a,” “an,” or “the” is not to be construed as limiting the element to the singular. Further, any reference to dispensing, disposing, depositing, dispersing, conveying, injecting, conveying, inserting, communicating, and other such terms of art are not to be construed as limiting the element to any particular means or method or apparatus or system, and is taken to mean conveying the material within the receiving vessel, solution, conduit, or the like by way of any suitable method.

Unless otherwise indicated, all numbers expressing quantities of equipment, number of steps, material quantities, material masses, material volumes, operating conditions, and so forth used in the specification and claims are to be understood as being modified in all instances by the term “about”. Accordingly, unless indicated to the contrary, the numerical parameters set forth in the present specification and attached claims are approximations that can vary depending upon the desired properties sought to be obtained by the present application. Generally, the term “about,” as used herein when referring to a measurable value such as an amount of weight, time, volume, ratio, temperature, etc., is meant to encompass±10% of the stated value. For example, a value of “1,000,” which would be construed from above as meaning “about 1,000,” indicates a range of values from 900 to 1,100, inclusive of all values and ranges therebetween. As another example, a value of “about 1,000” should be taken to indicate any single value or sub-range of values from 900 to 1,100, inclusive of the values 900 and/or 1,100. As such, if a value of “about 1,000” is disclosed or claimed, this disclosure or claim element includes, for example, the value of 900, the value of 900.0000000000001. the value of 900.1, the value of 901, . . . the value of 1,000, . . . the value of 1,099.9999999, the value of 1,100, and all values, ranges, sub-ranges, therebetween including values interstitial to adjacent integers or whole numbers, to any decimal place.

Generally, the term “substantially,” as used herein when referring to a measurable value, is meant to encompass ±10% of the stated value. Generally, the term “substantially,” as used herein with regard to a discrete position or orientation of a piece of equipment, component, or subcomponent, is meant to encompass the discrete position ±10% of the discrete position. Generally, the term “substantially,” as used herein with regard to a location of a piece of equipment, component, or subcomponent along a total range of travel of that equipment, component, or subcomponent, is meant to encompass ±10% of the location of the equipment, component, or subcomponent with regard to the total range of travel of that piece of equipment, component, or subcomponent, including translational travel, rotational travel, and extending travel in any direction, orientation, or configuration. As such, the use of the phrase “substantially disposed within a container” would be construed from above as meaning that greater than or equal to 90% of the subject element is disposed within the container. Likewise, the use of the phrase “substantially positioned within a bath” would be construed from above as meaning that greater than or equal to 90% of the subject element is positioned within the bath.

All transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Conventional terms in the fields of additive manufacturing, materials science, and chemistry have been used herein. The terms are known in the art and are provided only as a non-limiting example for convenience purposes. Accordingly, the interpretation of the corresponding terms in the claims, unless stated otherwise, is not limited to any particular definition. Thus, the terms used in the claims should be given their broadest reasonable interpretation.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components may be used in conjunction with the system. Therefore, it is to be understood that the inventions are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation. Specific equipment and materials described in the examples are for illustration only and not for purposes of limitation. For instance, any and all articles, portions of articles, structures, bulk materials, and/or the like, having any form factor, scale, dimensions, aesthetic attributes, material properties, internal structures, and/or mechanical properties, which are formed according to any of the disclosed methods, approaches, processes, or variations thereof, using any devices, equipment, apparatuses, systems, or variations thereof, using any of the build material, printing mixture, ink, yield-stress support material, or other material compositions described herein or variations thereof, are all contemplated and covered by the present disclosure. None of the examples provided are intended to, nor should they, limit in any way the scope of the present disclosure.

In this Detailed Description, various features may have been grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments may be combined with each other in various combinations or permutations. The scope of the embodiments should be determined with reference to the appended claims, along with the full scope of equivalents to which such claims are entitled.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that some or all of the parameters, dimensions, materials, equipment, processes, methods, and configurations described herein are meant to be preferred examples and that the actual parameters, dimensions, materials, and/or configurations will depend upon the specific application or applications for which the inventive teachings are used. Those skilled in the art will recognize many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” Any ranges cited herein are inclusive.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” may refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list. “or” or “and/or” shall be interpreted as being inclusive, i.e., the inclusion of at least one. but also including more than one of a number or list of elements, and, optionally, additional unlisted items. Only terms clearly indicated to the contrary, such as “only one of” or “exactly one of,” or, when used in the claims. “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of,” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein “at. %” refers to atomic percent, “vol. %” refers to volume percent, and “wt. %” refers to weight percent. However, in certain embodiments when “at. %” is utilized, the values described may also describe “vol. %” and/or “wt. %,” when “vol. %” is utilized, the values described may also describe “at. %” and/or “wt. %,” and when “wt. %” is utilized, the values described may also describe “at. %” and/or “vol. %.” For example, if “20 at. %” is described in one embodiment, in other embodiments the same description may refer to “20 wt. %” or “20 vol. %.” As a result, all “at. %” values should be understood to also refer to “wt. %” in some instances and “vol. %” in other instances, all “vol. %” values should be understood to also refer to “wt. %” values in some instances and “at. %” in other instances, and all “wt. %” values should be understood to refer to “at. %” in some instances and “vol. %” in other instances.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

1. A method comprising:
providing a first printing material comprising one or more engineering powders, one or more porogen materials, and one or more binder materials, the first printing material having a first porogen-to-engineering powder ratio;
communicating a mass of the first printing material into a printing space;
while communicating the mass of the first printing material into the printing space, at least partially solidifying the mass of the first printing material to form a first portion of a green part by dispersing a first volume of a non-solvent vapor to the mass of the first printing material to induce a phase separation of the one or more binder materials in the mass of the first printing material;
providing a second printing material comprising the one or more engineering powders, the one or more porogen materials, and the one or more binder materials, the second printing material having a second porogen-to-engineering powder ratio greater than the first porogen-to-engineering powder ratio;
communicating a mass of the second printing material into the printing space;
while communicating the mass of the second printing material into the printing space, at least partially solidifying the mass of the second printing material to form a second portion of the green part by dispersing a second volume of the non-solvent vapor to the mass of the second printing material to induce a phase separation of the one or more binder materials in the mass of the second printing material; and
increasing a temperature within the printing space to above a temperature threshold to sinter the green part, thereby forming a sintered part, wherein a difference between the first porogen-to-engineering powder ratio and the second porogen-to-engineering powder ratio results in the sintered part comprising a first sintered portion corresponding to the first portion of the green part that has a first porosity and a second sintered portion corresponding to the second portion of the green part that has a second porosity greater than the first porosity.

2. (canceled)

3. The method of claim 1, further comprising:
removing the one or more porogen materials from the green part.

4. (canceled)

5. The method of claim 1, further comprising:
adjusting an inter-filament spacing of the green part to spatially tune the porosity or a pore size of the sintered part.

6. The method of claim 1, further comprising:
at least partially coating the sintered part with a ceramic coating to form a finished part.

7. The method of claim 1, wherein the one or more engineering powders comprise one or more of: a ceramic, carbon, silica, clay, sand, silt, mud, loam, a metal, kaolinite, montmorillonite, hydrous aluminum phyllosilicates, illite, vermiculite, magnesium silicates, aluminum silicate hydroxide, porcelain, lime, iron oxide, magnesia, alumina, nitrides, carbides, beryllias, cerias, zirconias, borides, or silicides.

8. The method of claim 1, wherein the one or more engineering powders comprise a metal selected from among: stainless steel, carbon, iron, cobalt, chromium, titanium, gold, calcium, phosphorous, gallium, lithium, magnesium, manganese, silver, strontium, vanadium, aluminum, tantalum, nickel, nitrogen, copper, zinc, zirconium, hafnium, niobium, yttrium, thoria, or molybdenum.

9. The method of claim 1, wherein the one or more porogen materials comprise one or more of: a salt, a sugar, a wax, a gel, a protein, a peptide, a biomaterial, a sol-gel, a rubber, alginate, a polymer, high internal phase emulsions, polycaprolactone, calcium phosphate, or thermoplastic polymers.

10. The method of claim 1, wherein the one or more binder materials comprise a polymer.

11. (canceled)

12. The method of claim 1, wherein the sintering of the green part comprises one or more of: selective layer sintering, selective laser melting, electron beam melting, direct metal laser sintering, capacitor discharge sintering, continuous mesh belt furnace sintering, electro sinter forging, pressure-less sintering, microwave sintering, spark plasma sintering, electric current assisted sintering, transient liquid phase sintering, permanent liquid phase sintering, liquid phase sintering metallic powder sintering, hot isostatic pressing, direct current in vacuum sintering, sinter hardening, tempering, or fritting.

13. The method of claim 1, further comprising:
exposing an outer surface of the sintered part to microbes to induce mineralization to form a biocompatible bone tissue regrowth scaffold on the outer surface of the sintered part.

14. The method of claim 13, wherein exposing the outer surface of the sintered part to the microbes causes microbially-induced precipitation of one or more calcium derivatives onto the outer surface of the sintered part.

15-63. (canceled)

64. The method of claim 14, wherein the one or more calcium derivatives comprises one or more of: calcium phosphates, calcium carbonates, calcium silicates, hydroxyapatites, calcium-silicon-phosphates, calcium pyrophosphates, tricalcium phosphates, ferric calcium phosphorous oxides, octacalcium phosphates, or biphasic calcium phosphate bioceramics.

65. An apparatus comprising:
at least one processor; and
at least one memory storing instructions thereon that, when executed by the at least one processor, cause the apparatus to perform at least:
providing a first printing material comprising one or more engineering powders, one or more porogen materials, and one or more binder materials, the first printing material having a first porogen-to-engineering powder ratio;
communicating a mass of the first printing material into a printing space;
while communicating the mass of the first printing material into the printing space, at least partially solidifying the mass of the first printing material to form a first portion of a green part by dispersing a first volume of a non-solvent vapor to the mass of the first printing material to induce a phase separation of the one or more binder materials in the mass of the first printing material;
providing a second printing material comprising the one or more engineering powders, the one or more porogen materials, and the one or more binder materials, the second printing material having a second porogen-to-engineering powder ratio greater than the first porogen-to-engineering powder ratio;
communicating a mass of the second printing material into the printing space;
while communicating the mass of the second printing material into the printing space, at least partially solidifying the mass of the second printing material to form a second portion of the green part by dispersing a second volume of the non-solvent vapor to the mass of the second printing material to induce a phase separation of the one or more binder materials in the mass of the second printing material; and
increasing a temperature within the printing space to above a temperature threshold to sinter the green part, thereby forming a sintered part, wherein a difference between the first porogen-to-engineering powder ratio and the second porogen-to-engineering powder ratio results in the sintered part comprising a first sintered portion corresponding to the first portion of the green part that has a first porosity and a second sintered portion corresponding to the second portion of the green part that has a second porosity greater than the first porosity.

66. The apparatus of claim 65, wherein the instructions stored on the at least one memory, when executed by the at least one processor, further cause the apparatus to perform:
removing the one or more porogen materials from the green part.

67. The apparatus of claim 65, wherein the instructions stored on the at least one memory, when executed by the at least one processor, further cause the apparatus to perform:
adjusting an inter-filament spacing of the green part to spatially tune the porosity or a pore size of the sintered part.

68. The apparatus of claim 65, wherein the instructions stored on the at least one memory, when executed by the at least one processor, further cause the apparatus to perform:
at least partially coating the sintered part with a ceramic coating to form a finished part.

69. The apparatus of claim 65, wherein the instructions stored on the at least one memory, when executed by the at least one processor, cause the apparatus to perform the sintering of the green part by performing at least one of: selective layer sintering, selective laser melting, electron beam melting, direct metal laser sintering, capacitor discharge sintering, continuous mesh belt furnace sintering, electro sinter forging, pressure-less sintering, microwave sintering, spark plasma sintering, electric current assisted sintering, transient liquid phase sintering, permanent liquid phase sintering, liquid phase sintering metallic powder sintering, hot isostatic pressing, direct current in vacuum sintering, sinter hardening, tempering, or fritting.

70. The apparatus of claim 65, wherein the instructions stored on the at least one memory, when executed by the at least one processor, further cause the apparatus to perform:
exposing an outer surface of the sintered part to microbes to induce mineralization to form a biocompatible bone tissue regrowth scaffold on the outer surface of the sintered part.

71. The apparatus of claim 70, wherein the instructions stored on the at least one memory, when executed by the at least one processor, cause the apparatus to perform the exposing the outer surface of the sintered part to the microbes causes microbially-induced precipitation of one or more calcium derivatives onto the outer surface of the sintered part.

72. The apparatus of claim 71, wherein the one or more calcium derivatives comprises one or more of: calcium phosphates, calcium carbonates, calcium silicates, hydroxyapatites, calcium-silicon-phosphates, calcium pyrophosphates, tricalcium phosphates, ferric calcium phosphorous oxides, octacalcium phosphates, or biphasic calcium phosphate bioceramics.
